(19) United States
(12) Patent Application Publication
(10) Pub. No.: US 2014/0176570 A1
(43) Pub. Date: Jun. 26, 2014

(54) INTERFEROMETRIC LIGHT ABSORBING STRUCTURE FOR DISPLAY APPARATUS

(71) Applicant: PIXTRONIX, INC., San Diego, CA (US)

(72) Inventor: Jianru Shi, Haverhill, MA (US)

(73) Assignee: Pixtronix, Inc., San Diego, CA (US)

(21) Appl. No.: 13/725,272

(22) Filed: Dec. 21, 2012

(51) Int. Cl. H01L 31/00; G06T 1/20; H01L 31/18

(52) U.S. Cl. CPC H01L 31/00; H01L 31/18; G06T 1/20
USPC 345/501; 257/431; 438/57

(57) ABSTRACT

This disclosure provides systems, methods and apparatus related to light absorbing structures. In one aspect, a light absorbing structure has a metal layer and a semiconductor layer in contact with the metal layer. Each layer has a thickness up to about 50 nm. The metal layer can include at least one of titanium (Ti), molybdenum (Mo), and aluminum (Al). The semiconductor layer can include a layer of amorphous silicon (a-Si). The light absorbing structure can be included in a display apparatus having a substrate supporting an array of display elements. The light absorbing structure can include a dielectric layer in contact with the metal layer and a thick metal layer in contact with the semiconductor layer. In another aspect, a light absorbing structure has a metal layer and an ITO layer in contact with the metal layer. The thickness of the ITO layer can be less than about 100 nm.

### TECHNICAL FIELD

This disclosure relates to the field of electromechanical systems (EMS), and in particular, to light absorbing structures for use in a display apparatus.

### DESCRIPTION OF THE RELATED TECHNOLOGY

Some display devices incorporate light absorbing layers to reduce leakage of light from a backlight and to reduce reflection of light originating from an ambient environment back towards a viewer. The incorporation of such light absorbing layers into a display device serves to improve the image quality of display devices Previous light absorbing layers suffered from certain deficiencies. Specifically, the light absorbing layers sometimes can provide inadequate levels of light absorption, exhibiting a reflectance of about 20% to about 30%.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a light absorbing structure having a metal layer and a semiconductor layer in contact with the metal layer. Each of the metal layer and the semiconductor layer has a thickness less than or equal to about 50 nm. In some implementations, each of the metal layer and the semiconductor layer has a thickness less than or equal to about 25 nm. In some implementations, a reflectance of the light absorbing structure across at least a portion of the visible spectrum and across a range of incidence angles of about 45° about an axis normal to the light absorbing structure is less than about 15%.

In some implementations, the metal layer includes at least one of titanium (Ti), molybdenum (Mo), a Mo-containing alloy, and aluminum (Al). In some implementations, the semiconductor layer includes at least one of silicon (Si), amorphous silicon (a-Si) and germanium (Ge).

In some implementations, the metal layer is configured to absorb light corresponding to a primary color, and the semiconductor layer is configured to absorb light corresponding to a different primary color. In some implementations, the light absorbing structure includes a dielectric layer in contact with the metal layer. In some implementations, the light absorbing structure includes a second metal layer in contact with the semiconductor layer. In some implementations, the second metal layer has a thickness greater than the metal layer. In some implementations, a first semiconductor surface of the semiconductor layer is in contact with the first metal surface of the metal layer. The light absorbing structure includes a dielectric layer in contact with a second metal surface of the metal layer opposite the first metal surface and a second metal layer in contact with a second semiconductor surface of the semiconductor layer opposite the first semiconductor surface. The second metal layer has a thickness greater than the metal layer. In some implementations, the dielectric layer includes one of silicon nitride (SiNₓ) and indium tin oxide (ITO). In some implementations, the second metal layer has a thickness of at least 100 nm. In some implementations, the dielectric layer has a thickness greater than about 30 nm and less than about 300 nm.

In some implementations, the apparatus includes a display including the array of display elements, a processor that is configured to process image data and a memory device that is configured to communicate with the processor. In some implementations, the apparatus includes a driver circuit configured to send at least one signal to the display and the processor is further configured to send at least a portion of the image data to the driver circuit. In some implementations, the apparatus includes an image source module configured to send the image data to the processor. In some such implementations, the image source module includes at least one of a receiver, transceiver, and transmitter. In some implementations, the apparatus includes an input device configured to receive input data and to communicate the input data to the processor.

In some implementations, the display elements include electromechanical system (EMS) display elements. In some implementations, the display elements include microelectromechanical system (MEMS) display elements. In some implementations, the display elements include light modulators.

In some implementations, the apparatus further includes a first substrate configured to support the array of display elements and a second substrate separated from the first substrate. In some implementations, at least one of the first substrate, the second substrate and the display elements includes the light absorbing structure.

Another innovative aspect of the subject matter described in this disclosure can be implemented in a method of manufacturing a light absorbing structure. One of a metal layer and a semiconductor layer having a thickness of less than about 50 nm is deposited on a substrate. A second layer corresponding to the other of the metal layer and the semiconductor layer and having a thickness of less than about 50 nm is deposited directly on top of the one of the metal layer and the semiconductor layer that is deposited on the substrate. In some implementations, a reflectance of the light absorbing structure across at least a portion of the visible spectrum and across a 45° range of incidence angles is up to about 15%. In some implementations, the metal layer includes at least one of Ti, Mo, a Mo-containing alloy, and Al.

In some implementations, the semiconductor layer includes at least one of Si, a-Si and Ge. In some implementations, the metal layer is configured to absorb light corresponding to a primary color, and the semiconductor layer is configured to absorb light corresponding to a different primary color. In some implementations, the method includes depositing a dielectric layer. In some implementations, the method includes depositing a second metal layer having a thickness of greater than about 100 nm.

Another innovative aspect of the subject matter described in this disclosure can be implemented in an apparatus that includes a light absorbing structure having a metal layer having a thickness less than or equal to about 50 nm. The light absorbing structure also includes a second layer in contact with the metal layer. The second layer can be one of an ITO layer has a thickness that is less than or equal to about 100 nm or a high-refractive index dielectric layer having a thickness of less than or equal to about 200 nm. The refractive index of the high-refractive index dielectric layer is greater than or equal to about 1.7. In some implementations, a reflectance of the light absorbing structure across at least a portion of the visible spectrum and across a range of incidence angles of about 45° about an axis normal to the light absorbing structure is less than about 15%. In some implementations, the metal layer includes at least one of Ti, Mo, a Mo-containing alloy, and Al. In some implementations, the ITO layer has a thickness that is less than or equal to about 70 nm. In some implementations, the second layer includes one of SiNₓ and titanium oxide (TiO₂).

In some implementations, the light absorbing structure also includes a second metal layer in contact with the ITO layer. The second metal layer has a thickness greater than the metal layer. In some implementations, a first surface of the second layer is in contact with the first metal surface of the metal layer. In some such implementations, the light absorbing structure includes a dielectric layer in contact with a second metal surface of the metal layer opposite the first metal surface. A second metal layer is in contact with a second surface of the second layer opposite the first surface. The second metal layer has a thickness greater than the metal layer.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example schematic diagram of a direct-view MEMS-based display apparatus.

FIG. 1B shows an example block diagram of a host device.

FIG. 2A shows an example perspective view of an illustrative shutter-based light modulator.

FIG. 2B shows an example cross sectional view of a rolling actuator shutter-based light modulator.

FIG. 2C shows an example cross sectional view of an illustrative non shutter-based microelectromechanical systems (MEMS) light modulator.

FIG. 2D shows an example cross sectional view of an electrowetting-based light modulation array.

FIG. 3A shows an example schematic diagram of a control matrix.

FIG. 3B shows an example perspective view of an array of shutter-based light modulators connected to the control matrix of FIG. 3A.

FIGS. 4A and 4B show example views of a dual actuator shutter assembly.

FIG. 5 shows an example cross sectional view of a display apparatus incorporating shutter-based light modulators.

FIG. 6 shows an example cross sectional view of a light modulator substrate and an aperture plate for use in a MEMS-down configuration of a display.

FIG. 7 shows an example MEMS-down based display apparatus.

FIG. 8 shows an example multi-layer, light absorbing structure.

FIG. 9 shows an example multi-layer, light absorbing structure.

FIG. 10A shows an example cross-section of an aperture layer including a light absorbing structure.

FIG. 10B shows an example graph illustrating simulation results of the reflectance of visible light incident upon a surface of the aperture layer over different angles of incidence.

FIG. 11A shows an example cross-section of a shutter including a light absorbing structure.

FIG. 11B shows an example graph illustrating simulation results of the reflectance of visible light incident upon a surface of the shutter over different angles of incidence.

FIG. 12A shows an example cross-section of a shutter including a light absorbing structure.

FIG. 12B shows an example graph illustrating simulation results of the reflectance of visible light incident upon a surface of the shutter over different angles of incidence.

FIG. 13A shows an example cross sectional view of a light modulator substrate and an aperture plate for use in a MEMS-down configuration of a display.

FIG. 13B shows an example cross-section of a section of the display shown in FIG. 13A.

FIGS. 14A and 14B are examples of system block diagrams illustrating a display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

This disclosure relates to a light absorbing structure providing improved light absorption. The light absorbing structure includes a metal layer and a semiconductor layer in contact with the metal layer. In some implementations, the light absorbing structure includes a metal layer and an indium tin oxide (ITO) layer in contact with the metal layer. In some implementations, the light absorbing structure includes a metal layer and a high refractive index dielectric layer in contact with the metal layer. In some implementations, the high refractive index dielectric layer can have a refractive index that is greater than or equal to about 1.7. In some implementations, the high refractive index dielectric layer can be or includes silicon nitride (SiN) or titanium oxide (TiO₂).

The light absorbing structure provides a high level of light absorption by absorbing light in the constituent materials along with destructive interference of light reflected within the light absorbing structure. Both the absorption of light by constituent materials and the occurrence of destructive interference of light reflected within the light absorbing structure depend on the thicknesses of the constituent materials. To this end, the thicknesses of the layers are selected such that the overall absorptive properties of the light absorbing structure are improved. In some implementations, at least one of the metal layer and the semiconductor layer has a thickness up to about 50 nm. In some implementations, each of the metal layer and the semiconductor layer can have a thickness up to about 50 nm. In some implementations, the thickness of at least one of the layers is less than about 10 nm. In some implementations that include the metal layer and the ITO layer, at least one of the metal layer and the ITO layer has a thickness up to about 50 nm. In some implementations, the ITO layer can have a thickness up to about 100 nm. In some implementations, the thickness of the metal layer is less than about 10 nm. In some implementations, the high refractive index dielectric layer has a thickness of less than about 200 nm.

In some implementations, the metal layer includes a metal selected from titanium (Ti), aluminum (Al), and molybdenum (Mo). In some implementations, the semiconductor layer includes a semiconductor selected from silicon (Si) and germanium (Ge). For example, the metal layer can be a layer of Ti, and the semiconductor layer can be a layer of amorphous silicon (a-Si). In some implementations, the metal layer is configured to absorb light corresponding to a primary color (or a set of primary colors), and the semiconductor layer is configured to absorb light corresponding to a different primary color (or a different set of primary colors). In some implementations, each of the metal layer and the semiconductor layer is configured to absorb portions of light of one or more primary colors. In some implementations, each of the metal layer and the semiconductor layer is configured to absorb portions of light corresponding to the same colors. In some implementations, a reflectance of the light absorbing structure across at least a portion of the visible spectrum and across a 45° range of incidence angles is less than or equal to about 15%. That is, the light absorbing structure can absorb no less than about 85% of the light incident on the light absorbing structure. In some implementations, the reflectance of the light absorbing structure across the visible spectrum over the same range of incidence angles is no more than about 5%.

In some implementations, the light absorbing structure is incorporated in a display device. In such implementations, the light absorbing structure may be included in one or more surfaces of the display device. For example, the light absorbing structure may be included in a rear-facing surface of a light modulator that faces a backlight of a display. In this way, light from the backlight that is blocked by the light modulator may be absorbed by the light absorbing structure. Any light that is reflected off the rear-facing surface of the light modulator may impinge on a front-facing surface of a substrate positioned between the backlight and the light modulator. Accordingly, another example location where the light absorbing structure may be included is a front-facing surface of a substrate that faces a viewer of the display.

In some implementations, the light absorbing structure can form one or more electrical components that are part of the backplane circuitry. Examples of such electrical components include electrical interconnects, switches, transistors and capacitors. In some such implementations, the light absorbing structure can include a portion of the substrate on which the electrical component is formed. For example, an electrical interconnect formed on a substrate can be part of a light absorbing structure that includes the substrate, a first conductive layer having a thickness of about 50 nm-100 nm, a first metal layer having a thickness of 5 nm-20 nm, a second conductive layer having a thickness of about 50 nm-100 nm, a second metal layer having a thickness of 150 nm-300 nm, a third conductive layer having a thickness of about 50 nm-100 nm, a third metal layer having a thickness of 5 nm-20 nm and a fourth conductive layer having a thickness of 50 nm-100 nm. In some implementations, the metal layer is or includes Mo or a Mo-containing alloy. In some implementations, the conductive layer is or includes ITO.

Particular implementations of the subject matter described in this disclosure can be implemented to realize one or more of the following potential advantages. As described above, the absorption of light by constituent materials of the light absorbing structure and the occurrence of destructive interference of light reflected within the light absorbing structure provides improved light absorption. As a result, the reflectance of such light absorbing structures, in some implementations, can be less than about 10%, in some cases less than about 5%. Displays including such light absorbing structures can achieve improved contrast ratios, as well as, improved viewing angles. By improving the contrast ratio of the display, the color purity and the sharpness of the display improves. As a result, displays including such light absorbing structures can provide improved image quality.

In addition to improving contrast ratios, using certain of the light absorbing structures disclosed herein also can simplify the process of manufacturing displays. For example, Al generally has several desirable characteristics, but has proven difficult to use in some display structures, such as EMS shutters, due to its highly reflective nature. As disclosed herein, however, not only can a display incorporate Al in a shutter, but also it can use that Al as part of a light absorbing structure. Thus, the display is able to take advantage of the desirable characteristics of the material, while simultaneously using it to offset its own less desirable characteristics.

In some implementations, light absorbing structures can form one or more electrical components that are part of the backplane circuitry. Since electrical components generally include conductive layers, which make the electrical components reflective, forming the electrical components as part of the light absorbing structures can reduce the reflectance of the electrical components by absorbing light within the display that impinges on the electrical components, which improves the contrast ratio of the display.

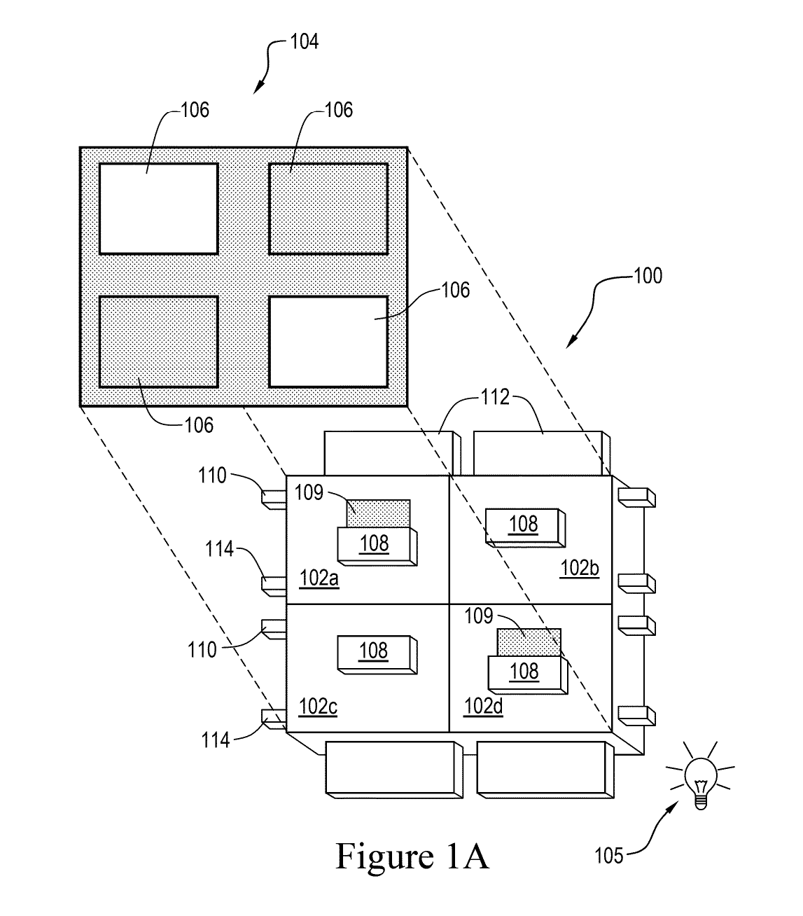

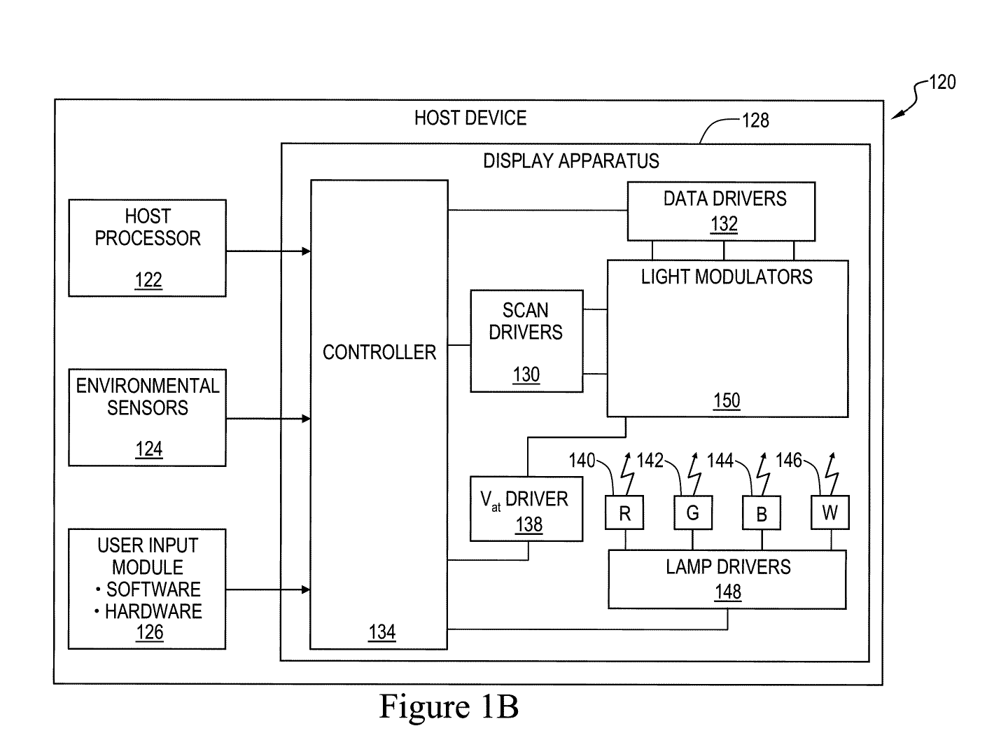

FIG. 1A shows a schematic diagram of a direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (for example, interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, for example, transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows an example of a block diagram of a host device 120 (i.e., cell phone, smart phone, PDA, MP3 player, tablet, e-reader, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (for example, scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

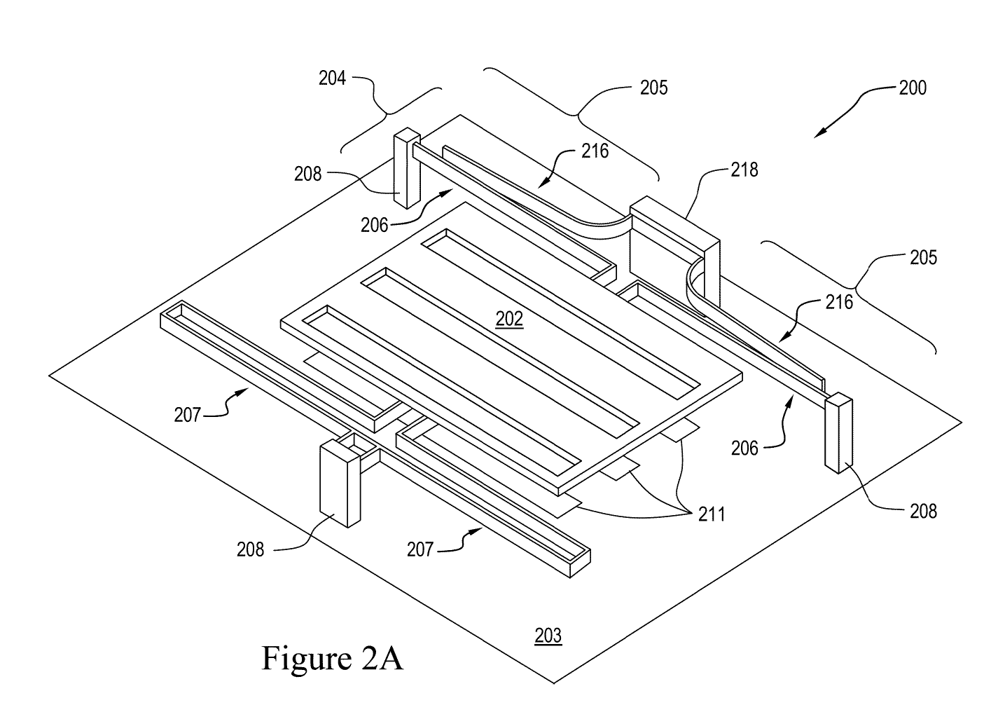

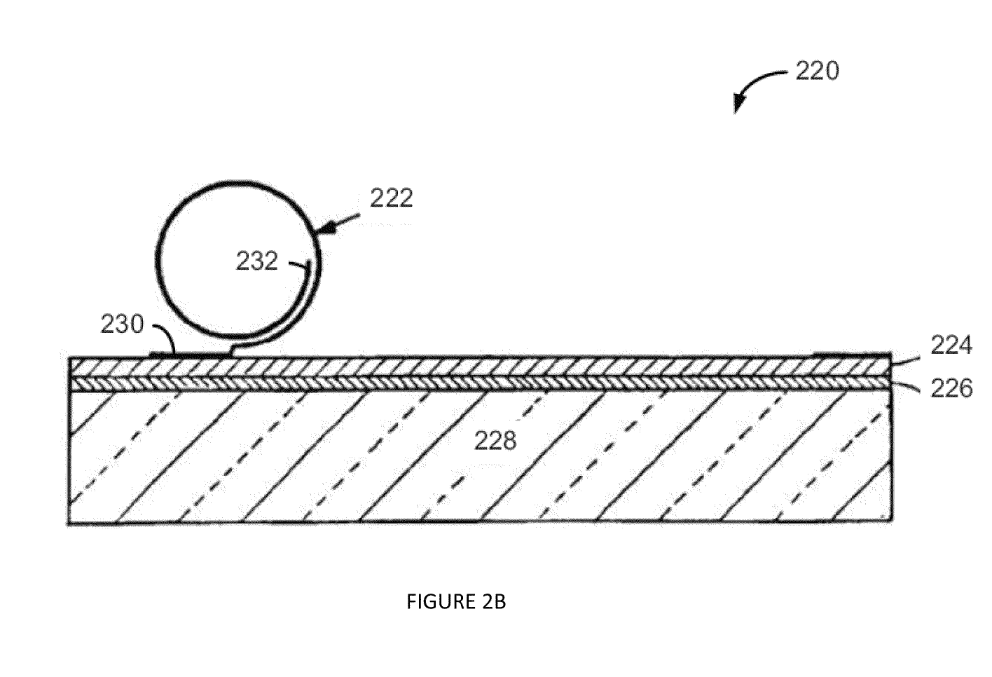

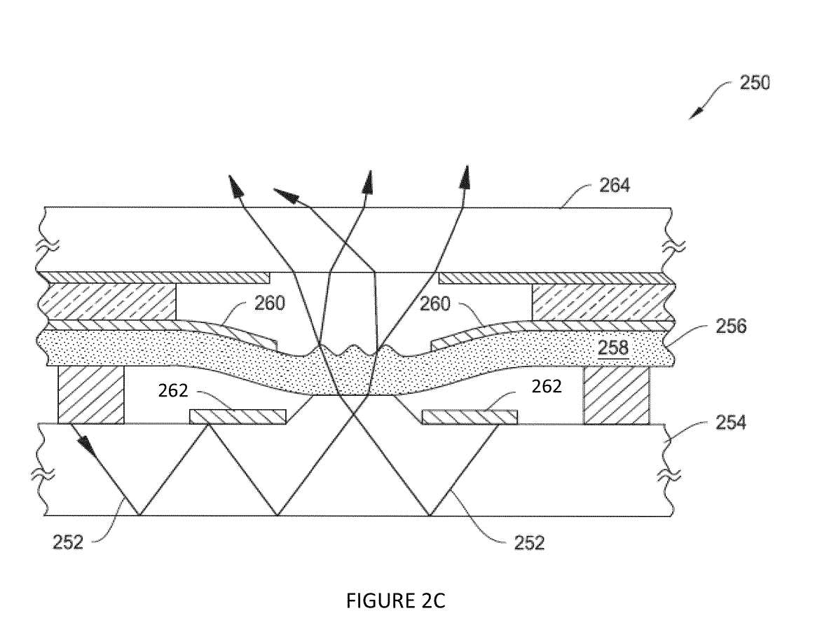

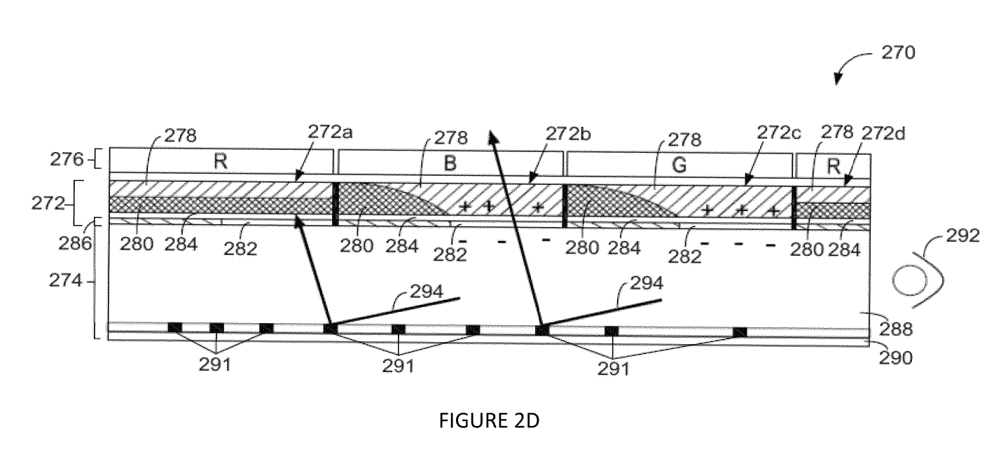

FIG. 2A shows a perspective view of an illustrative shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as Si, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

The display apparatus 100, in alternative implementations, includes display elements other than transverse shutter-based light modulators, such as the shutter assembly 200 described above. For example, FIG. 2B shows an example cross sectional view of a rolling actuator shutter-based light modulator 220. The rolling actuator shutter-based light modulator 220 is suitable for incorporation into an alternative implementation of the MEMS-based display apparatus 100 of FIG. 1A. A rolling actuator-based light modulator includes a movable electrode disposed opposite a fixed electrode and biased to move in a particular direction to function as a shutter upon application of an electric field. In some implementations, the light modulator 220 includes a planar electrode 226 disposed between a substrate 228 and an insulating layer 224 and a movable electrode 222 having a fixed end 230 attached to the insulating layer 224. In the absence of any applied voltage, a movable end 232 of the movable electrode 222 is free to roll towards the fixed end 230 to produce a rolled state. Application of a voltage between the electrodes 222 and 226 causes the movable electrode 222 to unroll and lie flat against the insulating layer 224, whereby it acts as a shutter that blocks light traveling through the substrate 228. The movable electrode 222 returns to the rolled state by means of an elastic restoring force after the voltage is removed. The bias towards a rolled state may be achieved by manufacturing the movable electrode 222 to include an anisotropic stress state.

FIG. 2C shows an example cross sectional view of an illustrative non shutter-based MEMS light modulator 250. The light tap modulator 250 is suitable for incorporation into an alternative implementation of the MEMS-based display apparatus 100 of FIG. 1A. A light tap works according to a principle of frustrated total internal reflection (TIR). That is, light 252 is introduced into a light guide 254, in which, without interference, light 252 is, for the most part, unable to escape the light guide 254 through its front or rear surfaces due to TIR. The light tap 250 includes a tap element 256 that has a sufficiently high index of refraction that, in response to the tap element 256 contacting the light guide 254, the light 252 impinging on the surface of the light guide 254 adjacent the tap element 256 escapes the light guide 254 through the tap element 256 towards a viewer, thereby contributing to the formation of an image.

In some implementations, the tap element 256 is formed as part of a beam 258 of flexible, transparent material. Electrodes 260 coat portions of one side of the beam 258. Opposing electrodes 262 are disposed on the light guide 254. By applying a voltage across the electrodes 260 and 262, the position of the tap element 256 relative to the light guide 254 can be controlled to selectively extract light 252 from the light guide 254.

FIG. 2D shows an example cross sectional view of an electrowetting-based light modulation array 270. The electrowetting-based light modulation array 270 is suitable for incorporation into an alternative implementation of the MEMS-based display apparatus 100 of FIG. 1A. The light modulation array 270 includes a plurality of electrowetting-based light modulation cells 272a-d (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from ITO) and an insulating layer 284 positioned between the layer of light absorbing oil 280 and the transparent electrode 282. In the implementation described herein, the electrode takes up a portion of a rear surface of a cell 272.

The remainder of the rear surface of a cell 272 is formed from a reflective aperture layer 286 that forms the front surface of the optical cavity 274. The reflective aperture layer 286 is formed from a reflective material, such as a reflective metal or a stack of thin films forming a dielectric mirror. For each cell 272, an aperture is formed in the reflective aperture layer 286 to allow light to pass through. The electrode 282 for the cell is deposited in the aperture and over the material forming the reflective aperture layer 286, separated by another dielectric layer.

The remainder of the optical cavity 274 includes a light guide 288 positioned proximate the reflective aperture layer 286, and a second reflective layer 290 on a side of the light guide 288 opposite the reflective aperture layer 286. A series of light redirectors 291 are formed on the rear surface of the light guide, proximate the second reflective layer. The light redirectors 291 may be either diffuse or specular reflectors. One or more light sources 292, such as LEDs, inject light 294 into the light guide 288.

In an alternative implementation, an additional transparent substrate (not shown) is positioned between the light guide 288 and the light modulation array 270. In this implementation, the reflective aperture layer 286 is formed on the additional transparent substrate instead of on the surface of the light guide 288.

In operation, application of a voltage to the electrode 282 of a cell (for example, cell 272b or 272c) causes the light absorbing oil 280 in the cell to collect in one portion of the cell 272. As a result, the light absorbing oil 280 no longer obstructs the passage of light through the aperture formed in the reflective aperture layer 286 (see, for example, cells 272b and 272c). Light escaping the backlight at the aperture is then able to escape through the cell and through a corresponding color filter (for example, red, green or blue) in the set of color filters 276 to form a color pixel in an image. When the electrode 282 is grounded, the light absorbing oil 280 covers the aperture in the reflective aperture layer 286, absorbing any light 294 attempting to pass through it.

The area under which oil 280 collects when a voltage is applied to the cell 272 constitutes wasted space in relation to forming an image. This area is non-transmissive, whether a voltage is applied or not. Therefore, without the inclusion of the reflective portions of reflective apertures layer 286, this area absorbs light that otherwise could be used to contribute to the formation of an image. However, with the inclusion of the reflective aperture layer 286, this light, which otherwise would have been absorbed, is reflected back into the light guide 290 for future escape through a different aperture. The electrowetting-based light modulation array 270 is not the only example of a non-shutter-based MEMS modulator suitable for inclusion in the display apparatus described herein. Other forms of non-shutter-based MEMS modulators could likewise be controlled by various ones of the controller functions described herein without departing from the scope of this disclosure.

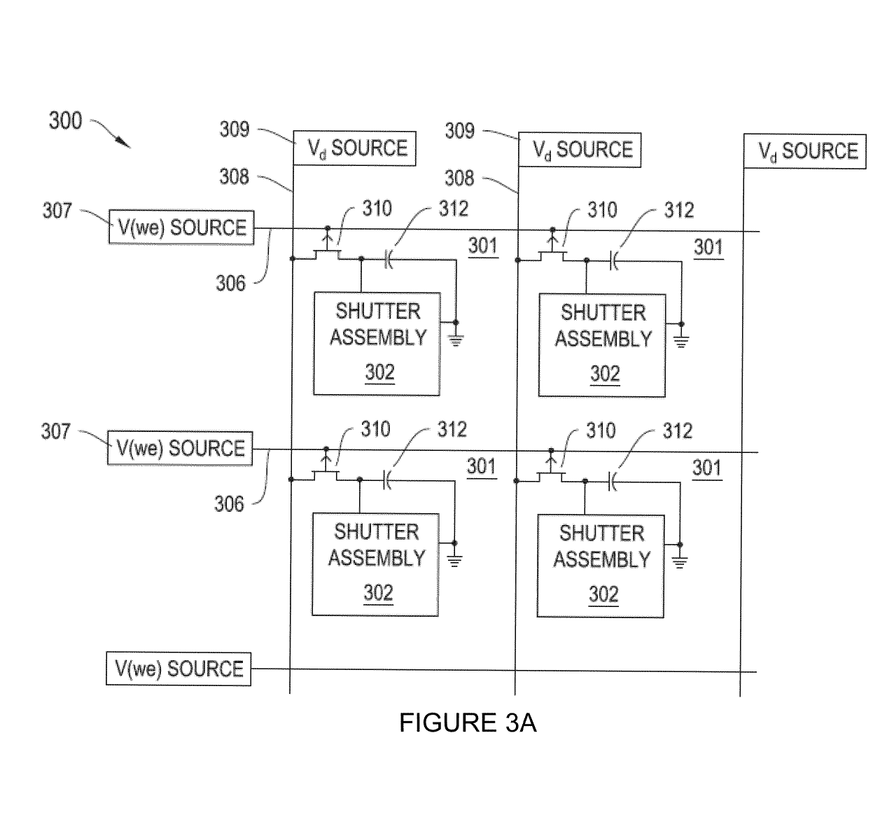

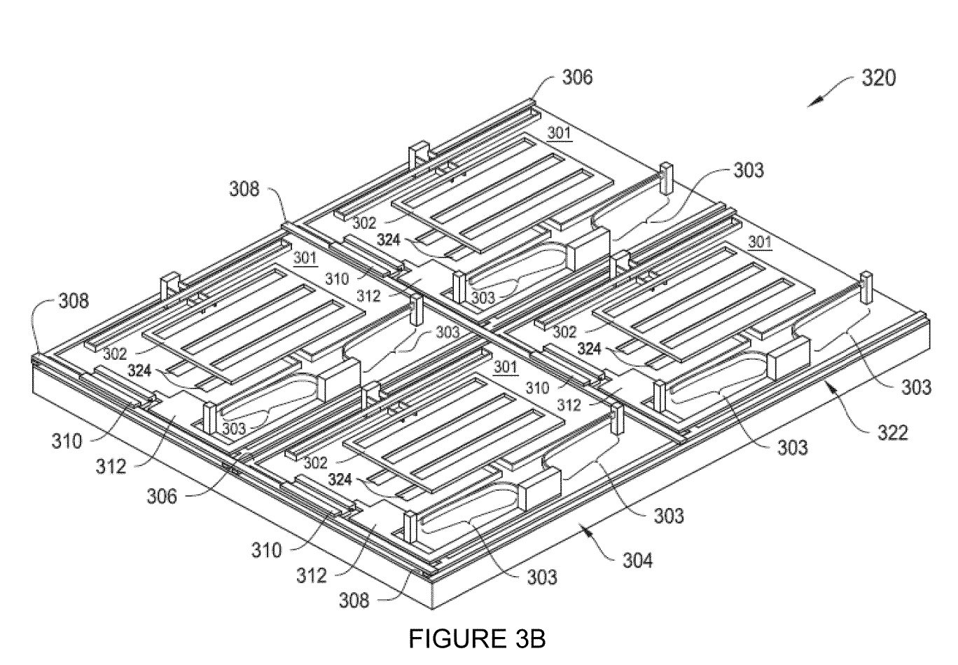

FIG. 3A shows an example schematic diagram of a control matrix 300. The control matrix 300 is suitable for controlling the light modulators incorporated into the MEMS-based display apparatus 100 of FIG. 1A. FIG. 3B shows a perspective view of an array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2A, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V, to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V, to a row. Therefore, the voltage V_{we} does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (for example, open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2A, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on’ or “off” optical states in each pixel. Certain forms of coded area division gray scale are possible where multiple MEMS light modulators in the pixel are provided, and where apertures 324, which are associated with each of the light modulators, have unequal areas.

In some other implementations, the roller-based light modulator 220, the light tap 250, or the electrowetting-based light modulation array 270, as well as other MEMS-based light modulators, can be substituted for the shutter assembly 302 within the light modulator array 320.

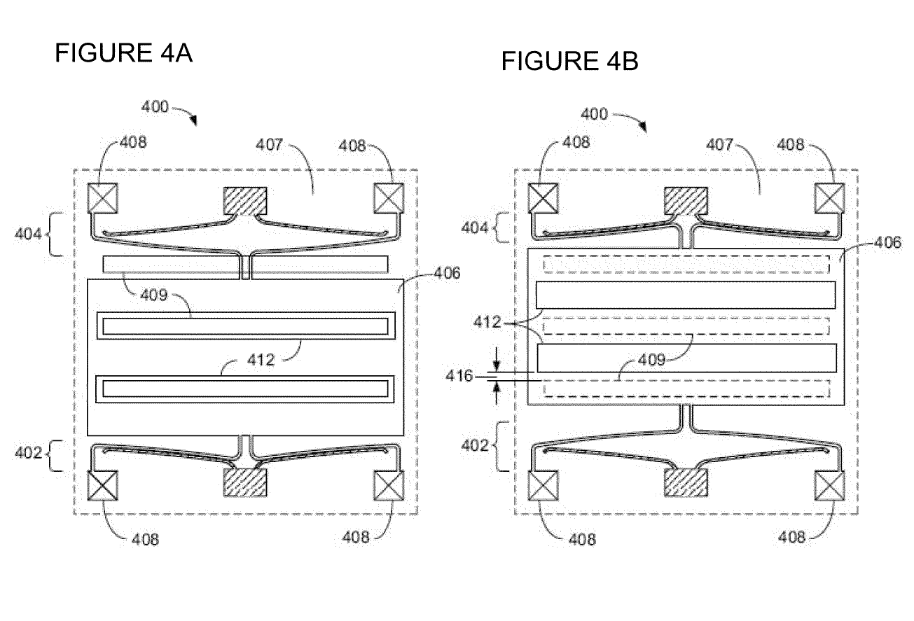

FIGS. 4A and 4B show example views of a dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

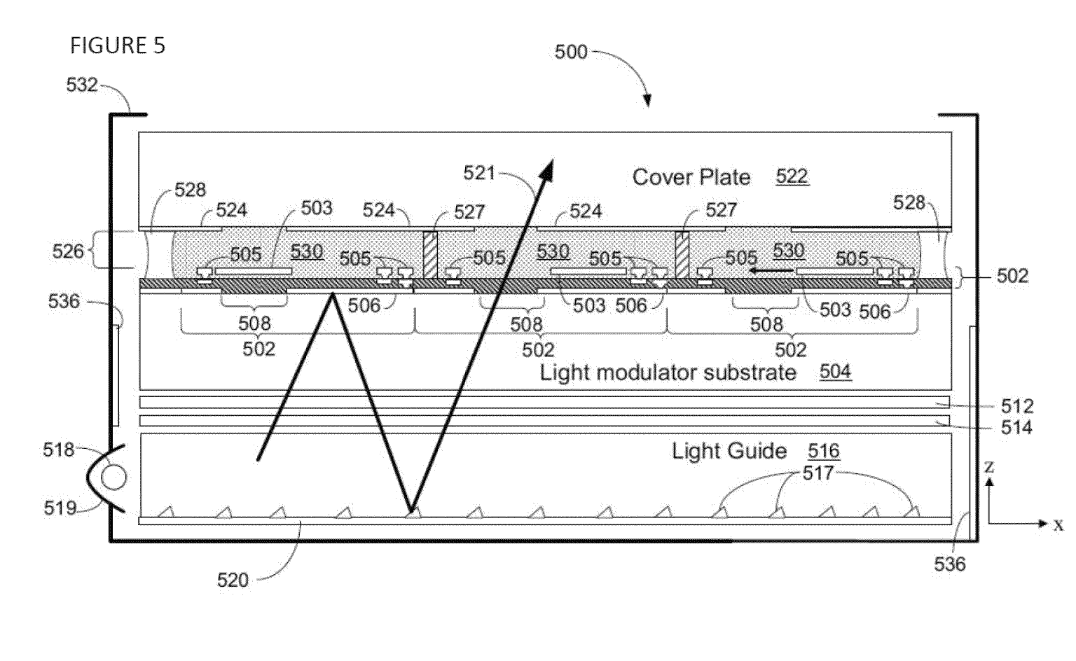

FIG. 5 shows an example cross sectional view of a display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such a substrate made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some other implementations, the rear-facing reflective layer 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505 (such as in the MEMS-down configuration described below).

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a predetermined distance away from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (for example, with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the lamps 518.

In some other implementations, the roller-based light modulator 220, the light tap 250, or the electrowetting-based light modulation array 270, as depicted in FIGS. 2A-2D, as well as other MEMS-based light modulators, can be substituted for the shutter assemblies 502 within the display apparatus 500.

The display apparatus 500 is referred to as the MEMS-up configuration, wherein the MEMS based light modulators are formed on a front surface of the substrate 504, i.e., the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective aperture layer 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

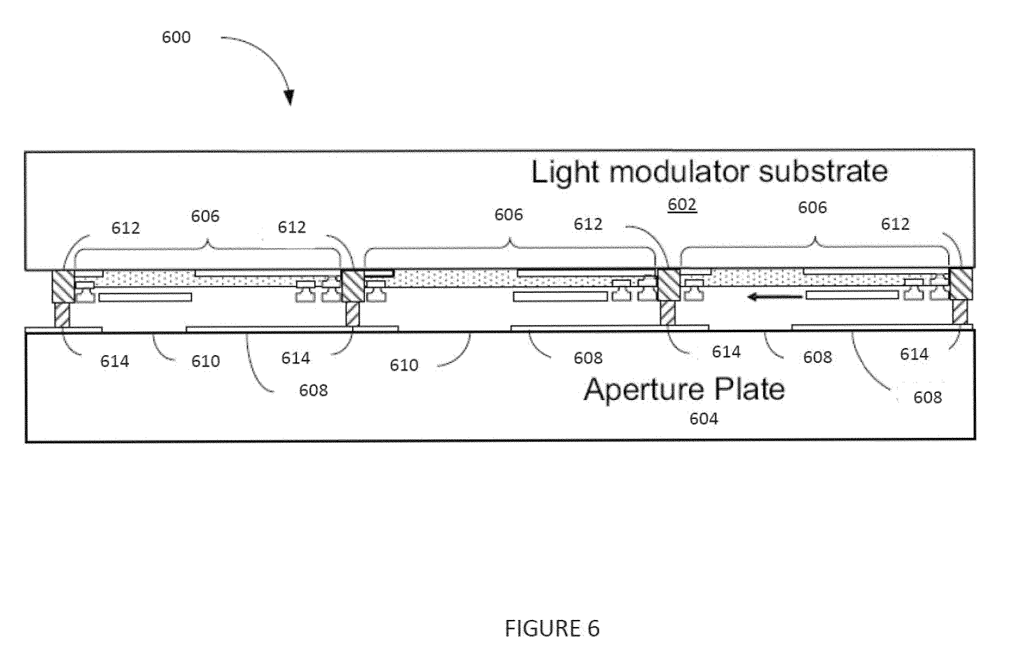

FIG. 6 shows an example cross sectional view of a light modulator substrate and an aperture plate for use in a MEMS-down configuration of a display. The display assembly 600 includes a modulator substrate 602 and an aperture plate 604. The display assembly 600 also includes a set of shutter assemblies 606 and a reflective aperture layer 608. The reflective aperture layer 608 includes apertures 610. A predetermined gap or separation between the modulator substrates 602 and the aperture plate 604 is maintained by the opposing set of spacers 612 and 614. The spacers 612 are formed on or as part of the modulator substrate 602. The spacers 614 are formed on or as part of the aperture plate 604. During assembly, the two substrates 602 and 604 are aligned so that spacers 612 on the modulator substrate 602 make contact with their respective spacers 614.

The separation or distance of this illustrative example is 8 microns. To establish this separation, the spacers 612 are 2 microns tall and the spacers 614 are 6 microns tall. Alternately, both spacers 612 and 614 can be 4 microns tall, or the spacers 612 can be 6 microns tall while the spacers 614 are 2 microns tall. In fact, any combination of spacer heights can be employed as long as their total height establishes the desired separation H12.

Providing spacers on both of the substrates 602 and 604, which are then aligned or mated during assembly, has advantages with respect to materials and processing costs. The provision of a very tall, such as larger than 8 micron spacers, can be costly as it can require relatively long times for the cure, exposure, and development of a photo-imageable polymer. The use of mating spacers as in display assembly 600 allows for the use of thinner coatings of the polymer on each of the substrates.

In another implementation, the spacers 612 which are formed on the modulator substrate 602 can be formed from the same materials and patterning blocks that were used to form the shutter assemblies 606. For instance, the anchors employed for shutter assemblies 606 also can perform a function similar to spacer 612. In this implementation, a separate application of a polymer material to form a spacer would not be required and a separate exposure mask for the spacers would not be required.

To improve contrast ratios of an EMS-based display device various surfaces of the display can include light absorbing structures to reduce the intensity of undesirable reflections. For instance, surfaces within the display can include a light absorbing structure that absorbs light that has been leaked from a backlight of the display or undesirably reflected off of other display device surfaces. However, existing light absorbing structures provide inadequate levels of light absorption, exhibiting a reflectance as low as about 20% to about 30%. As described herein, light absorbing structures that include a metal layer and a semiconductor layer in contact with one another provide improved levels of light absorption. For example, such light absorbing structures can exhibit reflectance levels that range from less than about 20% and in some cases as low as about 5%. As a result, when a display apparatus incorporates such light absorbing structures, the display apparatus can achieve increased contrast ratios.

In addition to improving contrast ratios, using certain of the light absorbing structures disclosed herein also can simplify the process of manufacturing displays. Existing displays incorporate shutters that are manufactured using Ti instead of Al, even though using Al would simplify the manufacturing process. This is because the relatively high reflectance of Al provides inadequate levels of light absorption, or stated in another way, significantly high light reflectance, that would result in unacceptable image quality. However, by forming light absorbing structures that include a metal layer and a semiconductor layer in contact with one another, improved levels of light absorption can be achieved. In particular, by forming light absorbing structures that include an Al layer in contact with a semiconductor layer, the manufacturing of such displays can be simplified, while achieving improved contrast ratios, and therefore improved image quality.

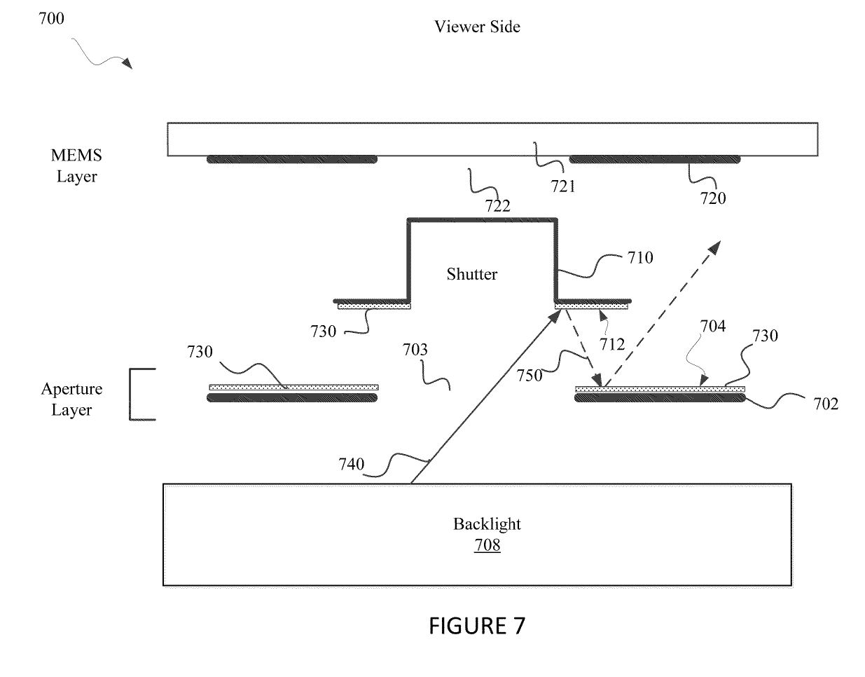

FIG. 7 shows a portion of an example MEMS-down based display apparatus 700. The display apparatus 700 has a MEMS-down configuration similar to the display apparatus 600 depicted in FIG. 6. The MEMS-down configuration includes MEMS based light modulators that are formed on a rear surface of a substrate facing away from the viewer. The display apparatus 700 includes a light blocking layer 720 that defines a plurality of apertures. The light blocking layer 720 is deposited on a MEMS substrate 721 that forms the front of the display apparatus 700. The MEMS substrate 721 supports a set of light modulators. At least one light modulator corresponds to each of the apertures defined by the light blocking layer 720. Each of the light modulators includes a light blocking element, such as a shutter 710. The display also includes an aperture layer 702, which is spaced apart from the MEMS substrate 721 by a gap. A rear-facing surface 712 of the shutter 710 faces towards a front-facing surface 704 of the aperture layer 702. The front-facing surface 704 of the aperture layer 702 faces towards a viewer of the display apparatus 700. The aperture layer 702 defines a set of apertures that correspond to the apertures defined by the light blocking layer 720.

Light from a backlight 708 can pass through an aperture of the aperture layer 702 and a corresponding aperture of the light blocking layer 720 based, at least in part, on the position of the shutter 710. When the shutter 710 is in the open position (not shown), light from the backlight 708 can pass through an aperture in the aperture layer 702 and a corresponding aperture in the light blocking layer 720 without being obstructed by the shutter 710. When the shutter 710 is in the closed position, light 740 from the backlight 708 may be blocked from passing through the aperture in the light blocking layer 720 by the rear-facing surface 712 of the shutter 710.

Various surfaces of the display apparatus 700 also include light absorbing structures 730. The light absorbing structures 730 reduce the rebounding of light blocked by the shutter 710, which might otherwise leak out of the display and decrease the display's contrast ratio. In particular, the rear-facing surface 712 of the shutter 710 includes the light absorbing structures 730. The light absorbing structure 730 on the shutter 710 helps prevent light 740 blocked by the shutter 710 from reflecting back towards the aperture layer 702. The front-facing surface 704 of the aperture layer 702 also includes the light absorbing structures 730. The light absorbing structure 730 on the aperture layer 702 absorbs light 750 that reflects off the shutter 710, preventing the light 750 from reflecting back towards, and potentially out of the display apparatus 700.

In some implementations, other surfaces of the display apparatus 700 also may include light absorbing structures 730. For example, a front-facing surface of the shutter 710 facing towards a viewer may include light absorbing structures 730. As another example, a rear-facing surface of the MEMS substrate 721 that faces towards the backlight 708 also may include light absorbing structures 730. In still some other implementations, the display apparatus 700 may include the light absorbing structure 730 only on the rear-facing surface 712 of the shutter 710 or only on the front facing side 704 of the aperture layer 702.

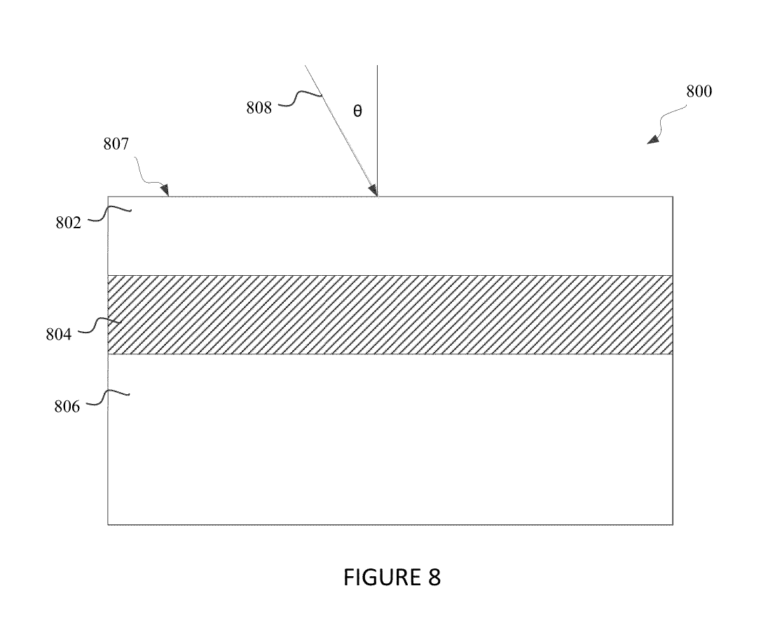

FIG. 8 shows an example light absorbing structure 800. In some implementations, the light absorbing structure 800 can be used as the light absorbing structures 730 depicted in FIG. 7. In some implementations, the light absorbing structure 800 can be incorporated in any display apparatus that generates images by modulating light using electromechanical system (EMS) light modulators, liquid crystal cells, light taps, or electrowetting cells, as well as a display apparatus that generates images by selectively emitting light, such as a plasma or organic light emitting diode (OLED) display. The light absorbing structure 800 also can be incorporated in a number of other devices, ranging from photo-detectors, energy-harvesting devices, other types of display devices, and so forth.

The light absorbing structure 800 includes a thin metal layer 802, a second light absorbing layer 804 and a base metal 806. The thin metal layer 802 is in contact with a first surface of the second light absorbing layer 804, while a second surface of the second light absorbing layer 804 opposite the first surface is in contact with the base metal 806.

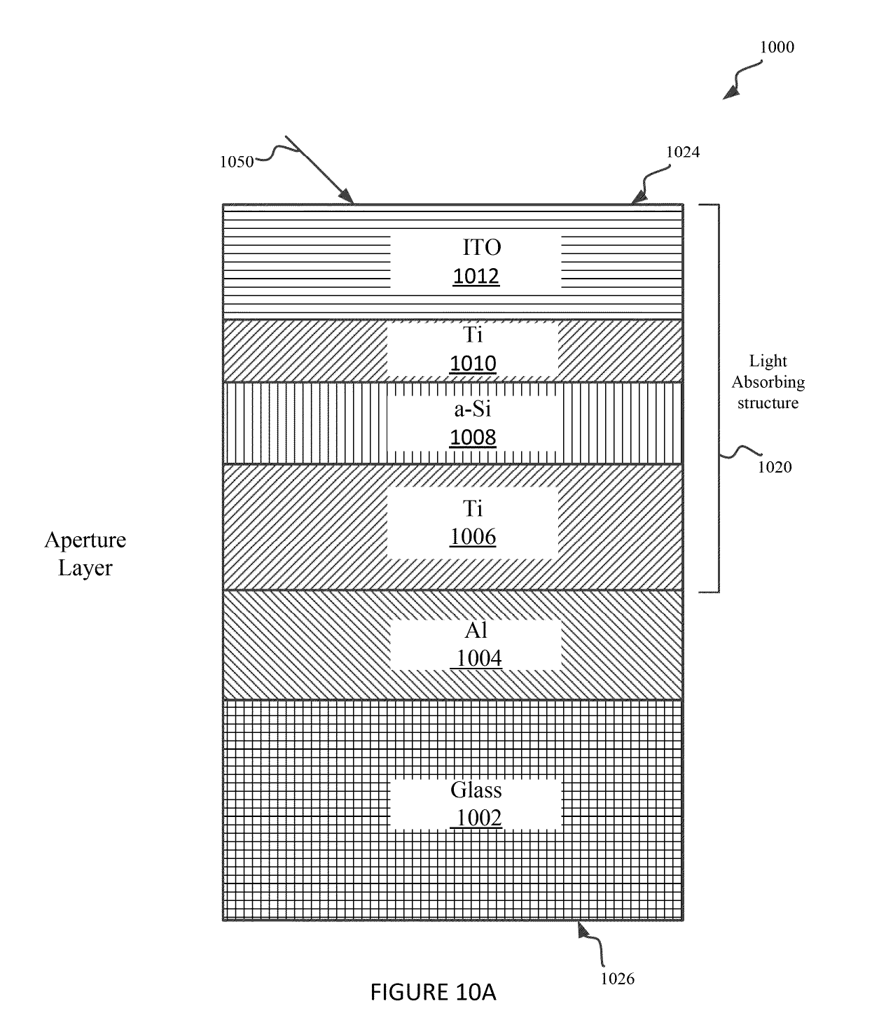

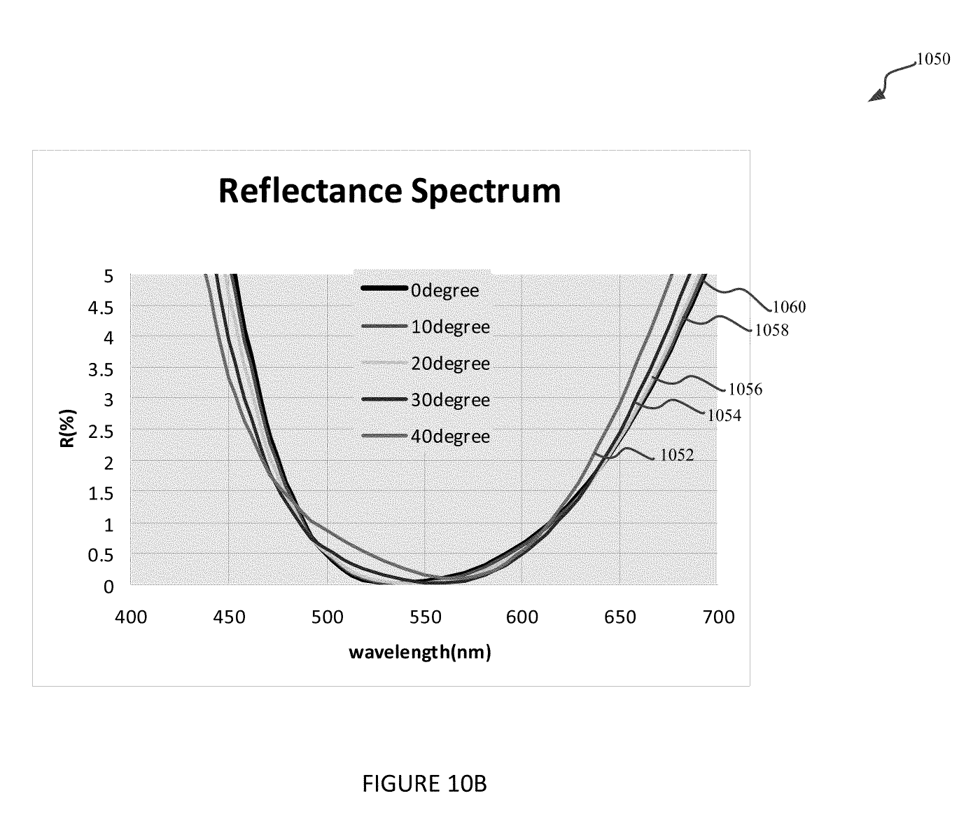

The light absorbing structure 800 provides a high level of light absorption, in part, due to the absorptive properties of the thin metal layer 802, the second light absorbing layer 804 and the base metal 806. In addition, the light absorbing structure 800 is configured such that inter-layer reflection is substantially reduced due to destructive interference. The overall level of light absorption relies on the properties of each of the materials, their refractive indexes and their thicknesses. Thus, the degree of destructive interference provided by the light absorbing structure 800 can be increased by adjusting the thicknesses of the constituent layers of material. Accordingly, the thickness of one or more of the metal layer 802, the second light absorbing layer 804 and the base metal 806 are tuned to yield improved light absorption characteristics. Specific thicknesses may be selected by use of optimization software configured to iteratively simulate various combination of material thicknesses. Several examples resulting from such simulations are described further in relation to FIGS. 10A-12B.

In the example depicted in FIG. 8, the metal layer 802 can be or includes Ti. Ti can provide a high level of absorption of light. Moreover, Ti can provide additional benefits in terms of compatibility with a manufacturing process, such as a manufacturing process of a MEMS-based display apparatus. Other suitable metals and metal alloys that can provide desired light absorption for one or more primary colors can be used in place of, or in combination with, Ti. Examples of some such metals and metal alloys include Al, Mo and Mo-containing alloys (for example, alloys of Mo and tungsten (W) and alloys of Mo and chromium (Cr)).

As depicted in FIG. 8, the second light absorbing layer 804 can be or includes Si, such as in the form of a-Si, single-crystal Si, polycrystalline Si, or a combination of such forms. Si, such as in the form of a-Si, can provide absorption of light by itself. Moreover, Si can provide additional benefits in terms of compatibility with a manufacturing process, such as a manufacturing process of a MEMS-based display apparatus. Other suitable materials that can provide desired light absorption can be used in place of, or in combination with, Si. Examples of some such semiconductors include Ge or other Group 4 elements. In some implementations, the second light absorbing layer 804 can be or includes ITO. In some other implementations, the second light absorbing layer 804 can be or includes a high refractive index dielectric material, for example, SiNₓ or titanium oxide (TiO₂).

In some implementations, the choice of materials for the metal layer 802 and the second light absorbing layer 804 also can affect the overall light absorption of the light absorbing structure. In particular, some metal materials become less transmissive when paired with certain materials. As such, when selecting materials for inclusion in the light absorbing structure 800, consideration should be given not only to tuning the thicknesses of the individual layers, but also to the type of materials used in each of the layers with respect to the other layer. For example, Al can become less reflective when paired with a semiconductor layer made from a-Si in contrast with a second light absorbing layer 804 that is or includes another material, for example, polysilicon or ITO. Similarly, Ti can become less reflective when paired with a layer made from ITO or SiNₓ in contrast with a semiconductor layer that is or includes a semiconductor material, for example, a-Si.

Still referring to FIG. 8, the metal layer 802 has an incident light-facing surface 807, which faces incident light 808 that can be absorbed by the light absorbing structure 800. The second light absorbing layer 804 is disposed below the thin metal layer 802 and is farther away from the incident light. The incident light 808 impinges on the light absorbing structure 800 at an incidence angle θ relative to an axis normal to the incident light-facing surface 807. Although not depicted in FIG. 8, one or more additional layers can be included above the light absorbing structure 800 to provide optical or other functionality, such as mechanical or electrical functionality.

During operation of the light absorbing structure 800, a certain fraction of incident light 808 is absorbed as it passes through the thin metal layer 802 by the thin metal layer 802. The metal layer is highly absorptive but also can be highly reflective. By combining the second light absorbing layer 804 with the thin metal layer 802, the light absorption by the thin metal layer 802 is enhanced. This is, in part, due to the occurrence of destructive interference that occurs at the interface of the metal layer 802 and the second light absorbing layer 804. The destructive interference can rebalance the transmission and reflection of light in each of the thin metal layer 802 and the second light absorbing layer 804. Light that is transmitted into the thin metal layer 802 that is not reflected or absorbed by the thin metal layer 802 is transmitted through to the second light absorbing layer 804. Some of the light that is transmitted through the thin metal layer 802 is reflected at the interface between the thin metal layer 802 and the second light absorbing layer 804. Some of this reflected light is absorbed by the metal layer 802. Some of the reflected light destructively interferes with the incident light that is transmitted through the metal layer 802, thereby enhancing the light absorption by the light absorbing structure. In addition, some of the light that is transmitted through the metal layer 802 in to the second light absorbing layer 804 is absorbed by the second light absorbing layer material. Substantially all of the remaining light that is transmitted in to the second light absorbing layer 804 is transmitted through the second light absorbing layer 804 into the base layer 806 and absorbed by the base layer 806.

The second light absorbing layer 804 can be relatively thin, while imparting a high level of light absorption by the resulting absorbing structure 800. As described above, the second light absorbing layer 804 can be or include a semiconductor material. In some such implementations, a thickness of the semiconductor layer 804 can be up to about 50 nm, such as up to about 30 nm or up to about 15 nm. In some implementations, the thickness of the semiconductor layer 804 can be down to about 15 nm, such as down to about 1 nm, or down to less than 1 nm.

In some implementations, the second light absorbing layer 804 can be or include an ITO layer. In some such implementations, the thickness of the ITO layer can be less than 200 nm, less than about 100 nm, less than about 70 nm, or less than about 50 nm. In some implementations, the second light absorbing layer 804 can be or include a high refractive index dielectric layer. In some such implementations, the thickness of the dielectric layer can be less than 300 nm, less than about 200 nm, or less than about 100 nm.

The light absorbing structure 800 can provide a decreased level of light reflectance. In some implementations, the reflectance of the light absorbing structure 800 for incident light across at least a portion of the visible spectrum (for example, 400 nm to 700 nm) and across about a 45° range of incidence angles. In some implementations, the range of incidence angles can be greater than 45°, for example, up to 60°. In some other implementations, the range of incidence angles can be can be smaller than 45°.

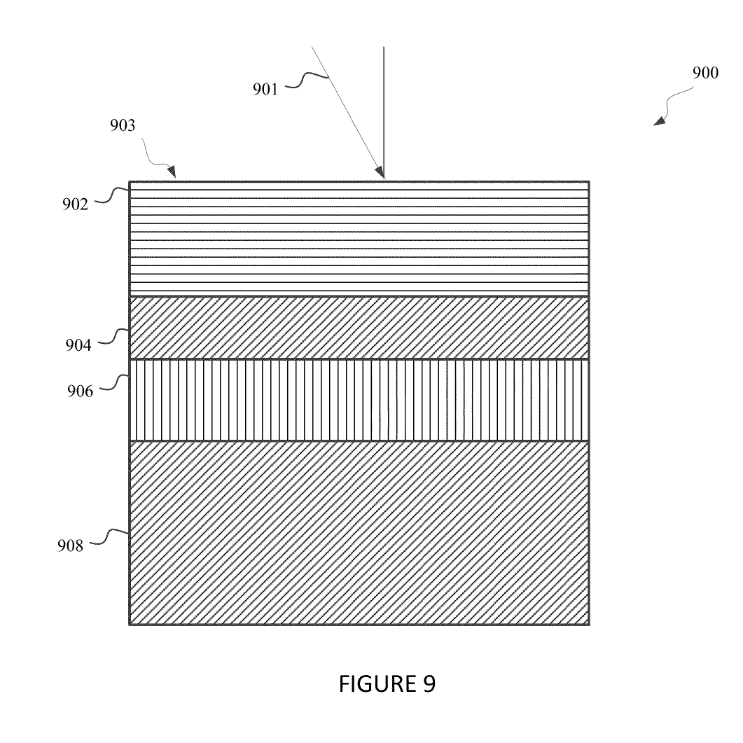

FIG. 9 shows an example multi-layer, light absorbing structure 900. The light absorbing structure 900 can be used as the light absorbing structures 730 depicted in FIG. 7. In some implementations, the light absorbing structure 900 can be incorporated in any display apparatus that generates images by modulating light using EMS light modulators, liquid crystal cells (such as LCDs), light taps, or electrowetting cells, as well as a display apparatus that generates images by selectively emitting light, such as a plasma or OLED display. The light absorbing structure 900 also can be incorporated in a number of other devices, ranging from photo-detectors, energy-harvesting devices, other types of display devices, and so forth.

The light absorbing structure 900 is similar to the light absorbing structure 800 depicted in FIG. 8 in that the light absorbing structure 900 is a four-layer stack. The light absorbing structure 900 includes a thin metal layer 904 and a semiconductor layer 906 in contact with the thin metal layer 904. In contrast to the light absorbing structure 800 depicted in FIG. 8, the light absorbing structure 900 also includes a dielectric layer 902 that is in contact with the thin metal layer 904. The dielectric layer 902 is in contact with the thin metal layer 904 along a surface of the thin metal layer 904 opposite to the surface of the thin metal layer 904 contacting the semiconductor layer 906. Further, the light absorbing structure 900 also includes a thick metal layer 908 that is in contact with the semiconductor layer 906 along a surface of the semiconductor layer 906 that is opposite to the surface of the semiconductor layer 906 contacting the thin metal layer 904. In some implementations, the thick metal layer 908 can be any base layer that is capable of absorbing light. Examples of materials that can be used in such base layers include metals, semiconductors, such as a-Si, and other light absorbing materials.

The light absorbing structure 900 provides a high level of light absorption by absorption of light by its constituent layers of material and due to destructive interference occurring within the light absorbing structure 900 and light reflected within the light absorbing structure 900. The degree of light absorption provided by a layer of material is generally proportional to its thickness. The degree of destructive interference provided by the light absorbing structure 900 can be increased by adjusting the thicknesses of the constituent layers of material. In some implementations, the thicknesses of the constituent layers of material can be adjusted such that the phase of light reflected within the materials is close or equal to 180° offset from the phase of incident light. Accordingly, the thickness of each of the layers 902-908 are tuned to yield improved light absorption characteristics. Specific thicknesses may be selected by use of optimization software configured to iteratively simulate various combination of material thicknesses.

In the example depicted in FIG. 9, the dielectric layer 902 can be or include ITO. Other example materials that can be used as a dielectric layer 902 include SiNₓ. In some implementations, the dielectric layer can be or include a dielectric material having a high refractive index, for example, materials having a refractive index greater than or equal to about 1.7. Examples of high-index dielectric materials include SiNₓ and TiO₂.

In some implementations, a thickness of the dielectric layer 902 can depend on the material of the dielectric. For example, in some implementations, if the dielectric layer 902 is or includes ITO, the thickness of the dielectric layer can be less than or equal to 100 nm. However, if the dielectric layer is or includes SiNₓ, the thickness of the dielectric layer 902 can be less than or equal to 200 nm. Generally, the thickness of the dielectric layer 902 can be between 30 nm and 300 nm; between 50 nm and 250 nm, or between 60 nm and 100 nm. The thickness and material of the dielectric layer 902 can be chosen such that the dielectric layer enhances transmission of light passing into the thin metal layer 904. Stated in another way, the dielectric layer is selected such that the amount of light that is reflected from the thin metal layer 904 is reduced.

The thin metal layer 904 can be or includes Ti. Ti can provide a high level of absorption of light corresponding to one primary color, namely red light. Moreover, Ti can provide additional benefits in terms of compatibility with a manufacturing process, such as a manufacturing process of a MEMS-based display apparatus. Other suitable metals and metal alloys that can provide desired light absorption for one or more primary colors can be used in place of, or in combination with, Ti. Examples of some such metals and metal alloys include Al, Mo and Mo-containing alloys (for example, alloys of Mo and W and alloys of Mo and Cr). In some implementations, the thickness of the metal layer 904 can be less than about 50 nm, less than about 30 nm, less than about 15 nm, less than about 10 nm or less than about 1 nm.

The semiconductor layer 906 can be or includes Si, such as in the form of a-Si, single-crystal Si, polycrystalline Si, or a combination of such forms. Other suitable semiconductors that can provide desired light absorption for one or more primary colors can be used in place of, or in combination with, Si. Examples of some such semiconductors include Ge or other Group 4 elements. In some implementations, the semiconductor layer 906 can be replaced with a layer of ITO. In such implementations, the thickness of the ITO layer can be less than about 200 nm, less than about 100 nm or less than about 70 nm. In some implementations, the semiconductor layer 906 can be replaced with a high refractive index dielectric layer that is or includes a high refractive index dielectric material. Examples of such dielectric materials include SiNₓ and TiO₂. In some such implementations, the thickness of the high refractive index dielectric layer can be less than about 300 nm, less than about 200 nm or less than about 100 nm.

In some implementations, the thickness of the semiconductor layer 906 can be less than about 50 nm, less than about 30 nm, less than about 15 nm, less than about 10 nm or less than about 1 nm. The thickness of the semiconductor layer 906 can be greater than the thickness of the thin metal layer 904 in some implementations. In some other implementations, the thickness of the semiconductor layer 906 can be smaller than, or substantially the same as, the thickness of the thin metal layer 904.

The thick metal layer 908 can be or includes Ti. In some implementations, the thick metal layer 908 and the thin metal layer 904 can be or include the same material. In some other implementations, the thick metal layer 908 can be or includes a material that is different from the material of the thin metal layer 904. In some implementations, a thickness of the thick metal layer 908 can be sufficiently thick such that the thick metal layer is substantially opaque. That is, almost all light passing through the metal layer 908 is either reflected or absorbed by the metal layer 908, such that substantially none of the light can pass completely through the thick metal layer. In some implementations, the thickness of the thick metal layer 908 is greater than about 50 nm, greater than about 100 nm, greater than about 150 nm, greater than about 200 nm, or greater than about 300 nm. In some implementations, the thickness of the thick metal layer 908 is less than about 1000 nm, less than about 500 nm, less than about 200 nm, or less than about 150 nm.

Still referring to FIG. 9, the dielectric layer 902 has an incident light facing surface 903, which faces incident light 901 that can be absorbed by the light absorbing structure 900. The dielectric layer 902 is selected such that the dielectric layer 902 enhances the transmission of the incident light 901 passing into the thin metal layer 904 compared to the transmission of light passing from silicone oil or other working fluid to the metal layer 802 depicted in FIG. 8. The thin metal layer 904 adjacent to the dielectric layer 902 is configured to perform two functions. First, the thin metal layer 904 absorbs a fraction of the light that is incident from the dielectric layer 902. Second, the thin metal layer 904 enhances the transmission of the remaining light into the semiconductor layer 906 such that the amount of light reflected by the thin metal layer 904 is reduced. The semiconductor layer 906 adjacent to the thin metal layer 904 is also configured to perform the same functions. Specifically, the semiconductor layer 906 is configured to absorb a fraction of the light that is incident from the thin metal layer 904 and enhance the transmission of the remaining light into the thick metal layer 908. In addition, each of the layers is configured such that the inter-layer reflection is minimized. In other words, each of the layers is sized such that amount of light reflected at the interface between two adjacent layers is minimized. To minimize the inter-layer reflection, the materials used in the layers can be configured to optically match with one another. As such, the materials, in particular their refractive indexes and their thicknesses are selected to increase light absorption and reduce the amount of light being reflected off the light absorbing structure. Although not depicted in FIG. 9, one or more additional layers can be included above the light absorbing structure 900 to provide optical or other functionality, such as mechanical or electrical functionality. One or more additional layers also can be included below the light absorbing structure 900 to provide optical or other functionality.

The light absorbing structure 900 can provide a decreased level of light reflectance. In some implementations, the reflectance of the light absorbing structure 900 for incident light across at least a portion of the visible spectrum (for example, 400 nm to 700 nm) and across about a 45° range of incidence angles. In some implementations, the range of incidence angles can be greater than 45°, for example, up to 60°. In some other implementations, the range of incidence angles can be can be smaller than 45°.

As described above, light absorbing structures can include a top coating layer that is either is or includes a non-conductive material, such as a dielectric, or a conductive material, such as a semiconductor or ITO. In some displays, the display is configured such that the aperture layer, such as the aperture layer 702 as shown in FIG. 7, can include a conductive top layer. In some such implementations, a light absorbing structure that includes a top coating layer that can be or includes a conductive material, such as a semiconductor or ITO is positioned on the aperture layer. Moreover, some displays are configured such that the top layer of a shutter, such as the shutter 710 shown in FIG. 7, be non-conductive. In some such implementations, a light absorbing structure positioned on the shutter includes a non-conductive top coating layer, such as a non-conductive high refractive index dielectric material, examples of which include SiNₓ and TiO₂.

FIG. 10A shows an example cross-section of an aperture layer 1000 including a light absorbing structure 1020. The light absorbing structure 1020 is implemented as a four-layer stack similar to the light absorbing structure 900 depicted in FIG. 9. The aperture layer 1000 may be incorporated into a display apparatus such that a front surface 1024 of the aperture layer 1000 faces towards a viewer.

In a MEMS-down configuration, the front surface 1024 of the aperture layer 1000 also faces light modulators corresponding to the display, while the bottom surface 1026 faces a light source, such as a backlight. For example, the aperture layer 1000 may be incorporated as the aperture layer 702 in the display apparatus 700 depicted in FIG. 7. In such implementations, the front surface 1024 corresponds to the front surface 704 of the aperture layer 702.

The aperture layer 1000 includes a glass substrate 1002 on which various layers are deposited. The first layer on top of the glass substrate is a layer of Al 1004. A first layer of Ti 1006 is deposited on top of the layer of Al 1004. A layer of a-Si 1008 is deposited on top of the layer of Ti 1006. A second layer of Ti 1010 is deposited on the layer of a-Si 1008. A layer of ITO 1012 is deposited on the second layer of Ti 1010.

The light absorbing structure 1020 is similar to the light absorbing structure 900 depicted in FIG. 9 in that they are both four-layer stacks. The light absorbing structure 1020 includes the first layer of Ti 1006, the layer of a-Si 1008, the second layer of Ti 1010 and the ITO layer 1012. The first Ti layer 1006 is opaque such that light does not transmit through the first Ti layer 1006. In some implementations, the first Ti layer should be sufficiently thick enough to prevent light from passing completely through the first Ti layer 1006. In some implementations, the first Ti layer 1006 has a thickness of about 200 nm. The second layer of Ti 1010 is about 6 nm thick. The layer of a-Si 1008 is about 13 nm thick. The ITO layer is about 66 nm thick. As described herein, the light absorption properties of the light absorbing structure 1020 may vary based on the selected thicknesses of the constituent layers of the light absorbing structure 1020. As such, in some implementations, other thicknesses may be selected to achieve different light absorption properties. Additional layers included above and below the light absorbing structure 1020 may be configured to provide other functionality. For example, the layer of Al 1004 can provide light recycling functionality by reflecting light back towards the backlight. In some implementations, other highly reflective materials instead of Al can be used. The light absorbing structure 1020 can provide light blocking functionality. In some implementations, the ITO layer also may be utilized due to its electrical conductance properties.

Although integrating the light absorbing structure 1020 into the aperture layer 1000 does not alter the light absorptive properties of the light absorbing structure 1020, the choice of materials and thicknesses of the additional layers may alter the overall light absorptive properties of the aperture layer. As such, when selecting different layers of materials for inclusion in an aperture layer, consideration should be given to the overall light absorptive properties of the aperture layer 1000 and not just the light absorptive properties of the light absorbing structure 1020.

FIG. 10B shows an example graph 1050 illustrating simulation results of the reflectance of visible light incident upon a surface of the aperture layer over different angles of incidence. The surface corresponds to the front surface 1024 of the aperture layer 1000 depicted in FIG. 10A. The graph 1050 includes a series of curves 1052-1062 generated by Advanced Systems Analysis Program (ASAP®) simulation software developed by Breault Research Organization, Inc., headquartered in Tucson, Ariz., USA. The curves 1052-1060 correspond to the reflectance of light incident upon the surface over different angles of incidence.

In particular, the graph 1050 includes a first curve 1052 indicating the reflectance of a range of wavelengths (400 nm-700 nm) of light incident upon the surface with a 40° angle of incidence, a second curve 1054 corresponding to a 30° angle of incidence, a third curve 1056 corresponding to a 20° angle of incidence, a fourth curve 1058 corresponding to a 10° angle of incidence and a fifth curve 1060 corresponding to a 0° angle of incidence. The photopic reflectance of light incident upon the surface for the range of incident angles between 0° and 45° is less than about 5. % at wavelengths between about 430 nm and about 680 nm.

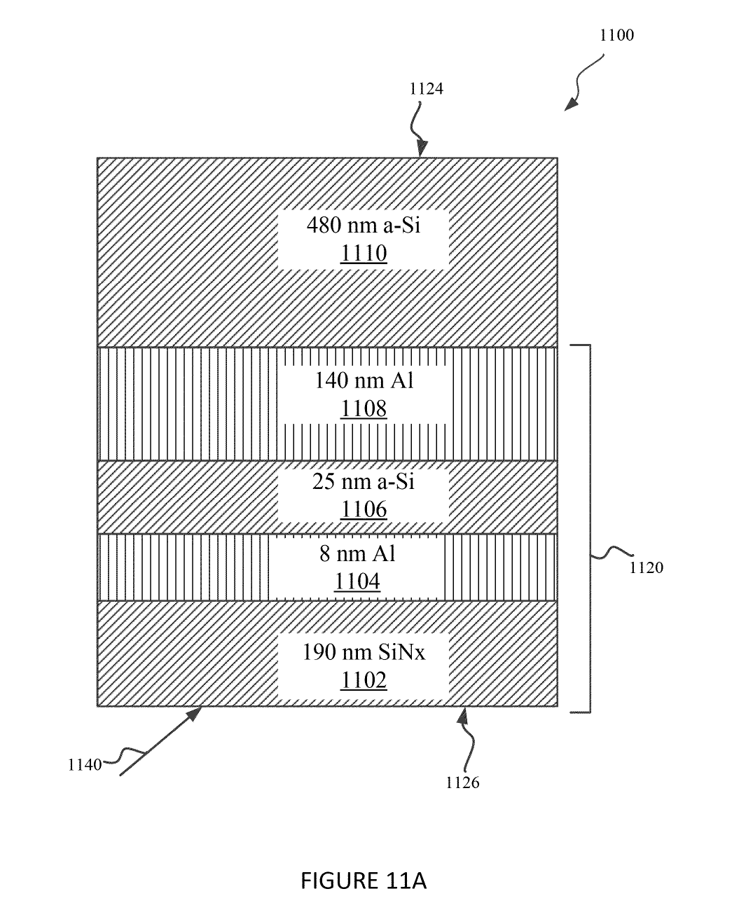

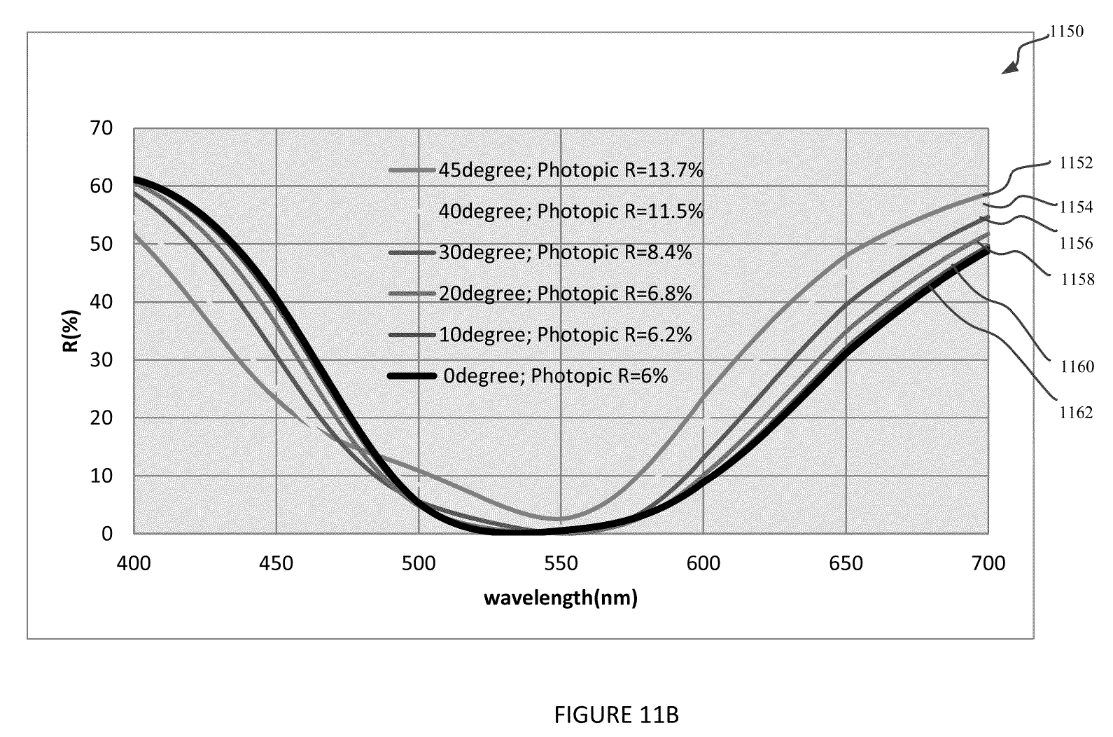

FIG. 11A shows an example cross-section of a shutter 1100 including a light absorbing structure 1120. The light absorbing structure 1120 is implemented as a four-layer stack similar to the light absorbing structure 900 depicted in FIG. 9. The shutter 1100 may be incorporated into a display apparatus such that a front surface 1124 of the shutter 1100 faces towards a viewer, while a rear surface 1126 of the shutter 1100 faces a backlight and corresponding front surface of an aperture layer.

In a MEMS-down configuration, the front surface 1124 of the shutter 1100 also faces towards a viewer, while the rear surface 1126 faces a light source, such as a backlight. For example, the shutter 1100 may be incorporated as the shutter 710 in the display apparatus 700 depicted in FIG. 7. In such implementations, the rear surface 1126 corresponds to the rear surface 712 of the shutter 710. The light 1140 corresponds to light from the backlight that is incident on the rear surface 1126 of the shutter 1100.

The shutter 1100 includes a layer of SiNₓ 1102, a first layer of Al 1104 above the layer of SiNₓ 1102, a first layer of a-Si 1106 above the first layer of Al 1104, a second layer of Al 1108 above the first layer of a-Si 1106 and a second layer of a-Si 1110 above the second layer of Al 1108. The second layer of a-Si 1110 serves as the mechanical base of the shutter 1100 on which the light absorbing structure 1120 can be formed. The light absorbing structure 1120 includes the layer of SiNₓ 1102, the first layer of Al 1104, the first layer of a-Si 1106 and the second layer of Al 1108 first layer of Al 1104. The layer of SiNₓ 1102 is about 190 nm thick. The first layer of Al 1104 is about 8 nm thick. The first layer of a-Si 1106 is about 25 nm thick. The second layer of Al 1108 is about 140 nm thick. The second layer of a-Si 1110 is about 480 nm thick. The additional layers included above the light absorbing structure 1120 may be configured to provide other functionality, including dielectric passivation, structural rigidity and light blocking functions. In some implementations, a non-conductive dielectric, such as SiNₓ, is used instead of a conductive dielectric, such as ITO. For example, shutters can include light absorbing structures that have a non-conductive dielectric layer. In such implementations, this is because the shutters are either manufactured alongside other display components that desire or utilize a non-conductive dielectric layer.

FIG. 11B shows an example graph 1150 illustrating simulation results of the reflectance of visible light incident upon a surface of the shutter 1100 over different angles of incidence. The surface corresponds to the rear surface 1126 of the shutter 1100 depicted in FIG. 11A. The graph includes a series of curves 1152-1162 generated by ASAP® simulation software. The curves 1152-1162 correspond to the reflectance of light incident upon the surface over a range of angles of incidence between 0° and 45°.

In particular, the graph 1150 includes a first curve 1152 indicating the reflectance of a light incident upon the surface at a 45° angle of incidence, a second curve 1154 indicating the reflectance of a light incident upon the surface at a 40° angle of incidence, a third curve 1156 indicating the reflectance of a light incident upon the surface at a 30° angle of incidence, a fourth curve 1158 indicating the reflectance of a light incident upon the surface at a 20° angle of incidence, a fifth curve 1160 indicating the reflectance of a light incident upon the surface at a 10° angle of incidence and a sixth curve 1162 indicating the reflectance of a light incident upon the surface at a 0° angle of incidence. The photopic reflectance of light incident upon the surface for the range of incident angles between 0° and 45° is between about 6% and about 13.7%.

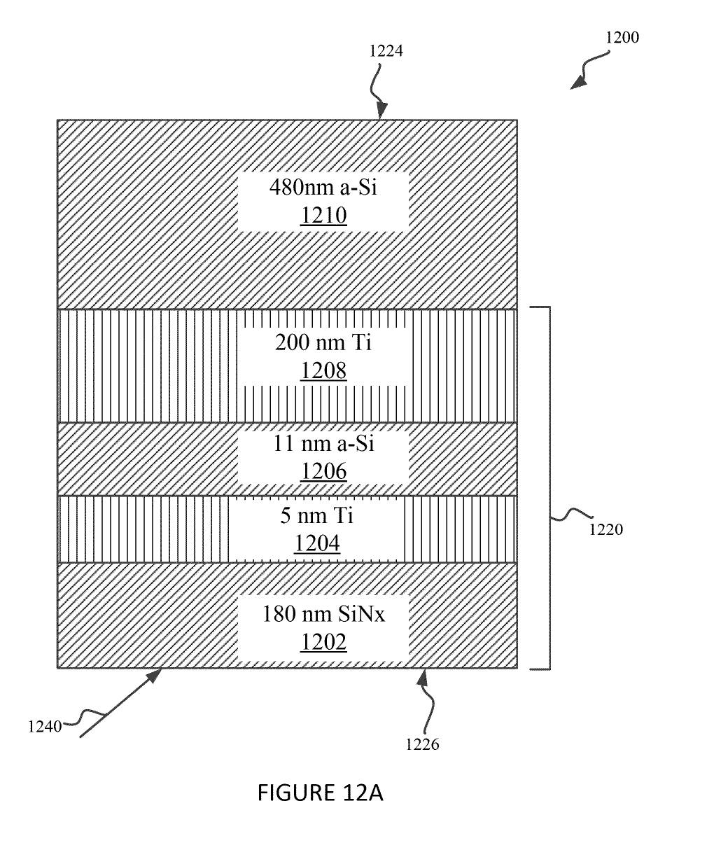

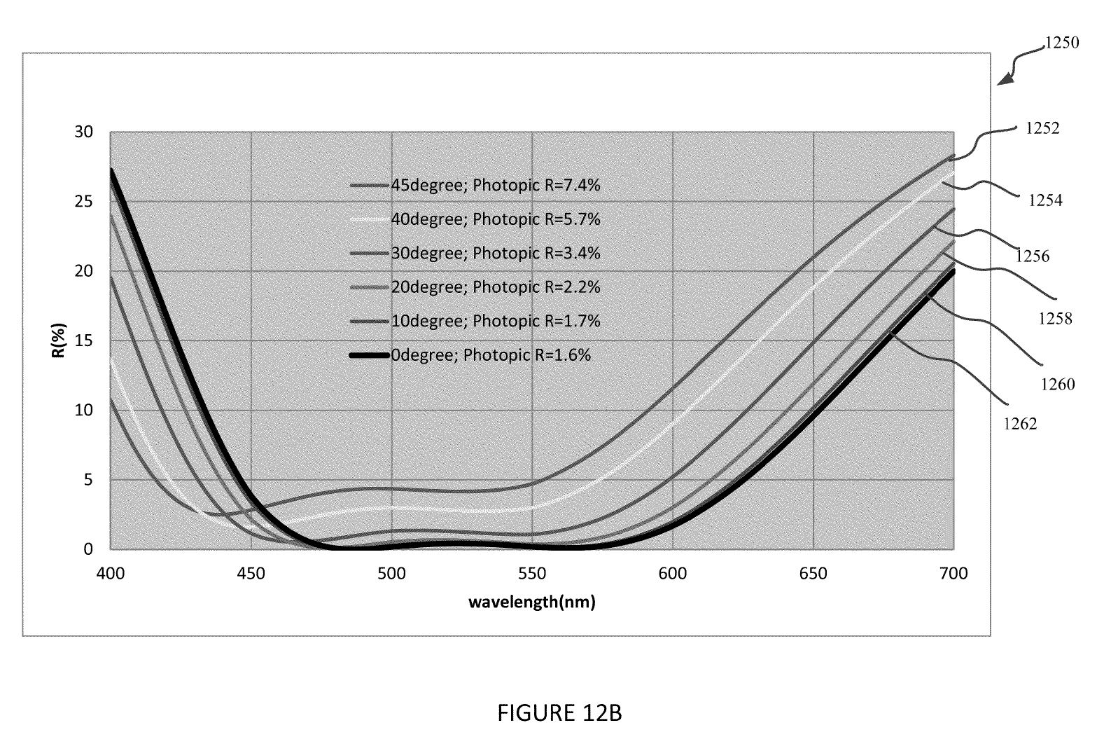

FIG. 12A shows an example cross-section of a shutter 1200 including a light absorbing structure 1220. The light absorbing structure 1220 is implemented as a four-layer stack. Similar to the shutter 1100 depicted in FIG. 11A, the shutter 1200 may be incorporated into a display apparatus such that a front surface 1224 of the shutter 1200 faces towards a viewer, while a rear surface 1226 of the shutter 1200 faces a backlight and corresponding front surface of an aperture layer. Light 1240 corresponds to light from the backlight that is incident on the rear surface 1226 of the shutter 1200.

In contrast to the shutter 1100 depicted in FIG. 11A, the shutter 1200 includes a light absorbing structure 1220 that includes a layer of SiNₓ 1202, a first layer of Ti 1204 above the layer of SiNₓ 1202, a first layer of a-Si 1206 above the first layer of Ti 1204, a second layer of Ti 1208 above the first layer of a-Si 1206. The shutter 1240 also includes a second layer of a-Si 1210 above the second layer of Al 1208. This second layer of a-Si 1210 serves as the mechanical base of the shutter 1100 on which the light absorbing structure 1220 can be formed. The layer of SiNₓ 1202 is about 180 nm thick. The first layer of Ti 1204 is about 5 nm thick. The first layer of a-Si 1206 is about 11 nm thick. The second layer of Ti 1208 is about 200 nm thick. The second layer of a-Si 1110 is about 480 nm thick. Any additional layers included above the light absorbing structure 1220 may be configured to provide other functionality, including dielectric passivation, structural rigidity and light blocking functions.

FIG. 12B shows an example graph 1250 illustrating simulation results of the reflectance of visible light incident upon a surface of the shutter 1200 over different angles of incidence. The surface corresponds to the rear surface 1226 of the shutter 1200 depicted in FIG. 12A. The graph includes a series of curves 1252-1262 generated by ASAP® simulation software. The curves 1252-1262 correspond to the reflectance of light incident upon the surface over a range of angles of incidence between 0° and 45°.

In particular, the graph 1250 includes a first curve 1252 indicating the reflectance of a light incident upon the surface at a 45° angle of incidence, a second curve 1254 indicating the reflectance of a light incident upon the surface at a 40° angle of incidence, a third curve 1256 indicating the reflectance of a light incident upon the surface at a 30° angle of incidence, a fourth curve 1258 indicating the reflectance of a light incident upon the surface at a 20° angle of incidence, a fifth curve 1260 indicating the reflectance of a light incident upon the surface at a 10° angle of incidence and a sixth curve 1262 indicating the reflectance of a light incident upon the surface at a 0° angle of incidence. The photopic reflectance of light incident upon the surface for the range of incident angles between 0° and 45° is between about 1.6% and 7.4%.

The ambient reflectivity and contrast ratio of a display depends on the reflectivity of the surface with which ambient light interacts. In addition, the contrast ratio also depends on the reflectivity of components within the display apparatus.

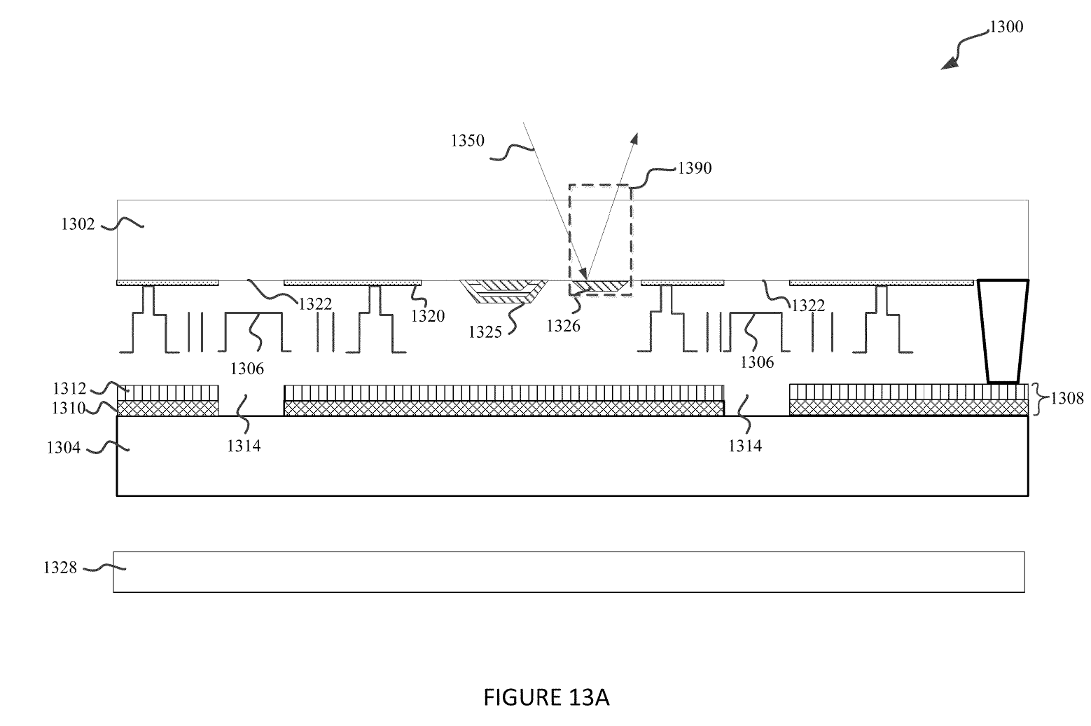

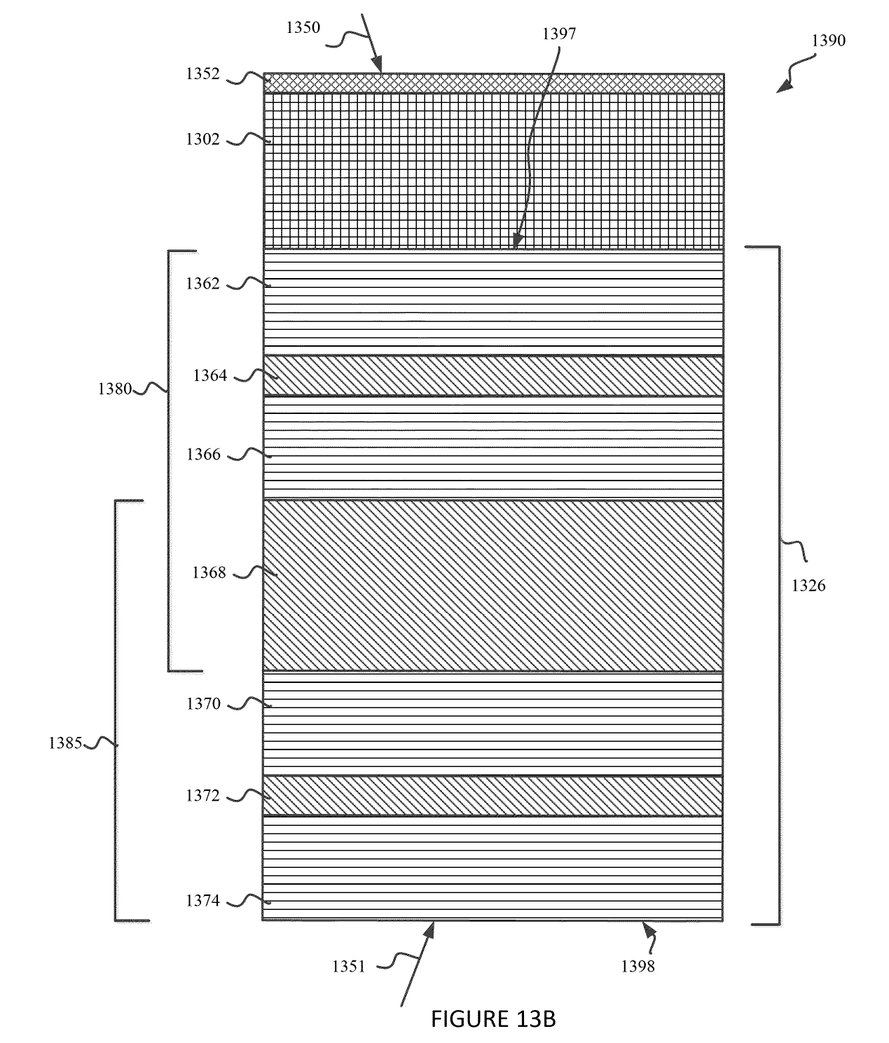

FIG. 13A shows an example cross sectional view of a display assembly 1300. The display assembly 1300 includes a modulator substrate 1302 and an aperture plate 1304 for use in a MEMS-down configuration. The display assembly 1300 also includes a set of shutter assemblies 1306 and an aperture layer 1308 that includes a light reflecting layer 1312 formed on top of a light absorbing layer 1310. The aperture layer 1308 includes apertures 1314 and is formed on the aperture plate 1304. The modulator substrate 1302 has a front surface facing a viewer and a rear surface facing a backlight 1328. In some implementations, the front surface can be coated with an anti-reflective layer. The rear surface of the modulator substrate 1302 can be coated with a light absorbing layer 1320 through which apertures 1322 are formed.

Various electrical components, including switches, transistors, such as transistor 1325, capacitors and interconnects, such as electrical interconnect 1326 form the backplane circuits that control the shutter assemblies 1306. These components also occupy regions on the rear surface of the modulator substrate 1302 between the apertures 1322. As such, some of these electrical components can face the front of the display. Since many of these electrical components are composed of conductive materials, they tend to be reflective. As such, when ambient light interacts with the front of the display, light can reflect off the modulator substrate 1302 or the underlying electrical components towards the viewer. Since electrical interconnects form a majority of the backplane circuitry, their reflectivity tends to increase the overall ambient reflectivity of the display.

In fact, electrical interconnects formed in a display apparatus can adversely affect the contrast ratio of the display regardless of the location of the electrical interconnects within the display. This is because light within the display apparatus can reflect off the electrical interconnects towards the front of the display.

In some implementations, electrical interconnects can be or can include a light absorbing structure. In some other implementations, an electrical interconnect can be a part of a larger light absorbing structure. As shown in FIG. 13A, the electrical interconnect 1326 itself is a light absorbing structure. As such, the electrical interconnect 1326 not only serves as an electrical interconnect, but also absorbs ambient light interacting with a front facing surface of the electrical interconnect 1326 as well as light within the display that interacts with a rear facing surface of the electrical interconnect 1326.

In some implementations, one or more of the other electrical components, for example, transistors, such as the transistor 1325, capacitors, and switches also can be or include light absorbing structures. In some other implementations, one or more of these electrical components can be a part of larger light absorbing structures. That is, layers that form the light absorbing structures can serve as one or more of the layers of various electrical components. In some implementations, electrodes of the transistors, such as transistor 1325, metal plates of the capacitors, bus lines, and interconnects, such as the interconnect 1326 can be formed by one or more of the layers of such light absorbing structures. In this way, the electrical components can not only provide particular functionality related to the backplane circuitry, but also function to provide light absorption. The electrical interconnect 1326 is configured to be a light absorbing structure, i.e., to have low reflectance. Additional details of the electrical interconnect 1326 formed as a light absorbing structure are provided below with respect to FIG. 13B.

FIG. 13B shows an example cross-section of a section 1390 of the display 1300 shown in FIG. 13A. The section 1390 includes a portion of the modulator substrate 1302. The modulator substrate 1302 has a front surface on which an anti-reflective layer 1352 is coated and a rear surface on which the electrical interconnect 1326 is formed.

The electrical interconnect 1326 has a light reflectance that is less than about 1%. In some implementations, the electrical interconnect 1326 can have a light reflectance of less than about 0.5%.

In some implementations, the electrical interconnect 1326 can be formed on the rear surface of the modulator substrate 1302 facing the backlight 1328. The electrical interconnect 1326 includes a multi-layer stack including a first conductive layer 1362, a first metal layer 1364, a second conductive layer 1366, a second metal layer 1368, a third conductive layer 1370, a third metal layer 1372 and a fourth conductive layer 1374. In this example, the first conductive layer 1362 is in contact with the modulator substrate 1302 on one side and contacts the first metal layer 1364 on the opposite side. The second conductive layer 1366 is stacked on top of the first metal layer 1364, the second metal layer 1368 is stacked on top of the second conductive layer 1366, the third conductive layer 1370 is stacked on top of the second metal layer 1368, the third metal layer 1372 is stacked on top of the third conductive layer 1370 and a fourth conductive layer 1374 is stacked on top of the third metal layer 1372.

In some implementations, the first metal layer 1364, the second conductive layer 1366 and the second metal layer 1368 form a front-facing light absorbing portion 1380 of the electrical interconnect 1326. The front-facing light absorbing portion 1380 contributes towards the absorption of ambient light that interacts with the front surface 1397 of the electrical interconnect 1326. The second metal layer 1368, the third conductive layer 1370, the third metal layer 1372 form a rear-facing light absorbing portion 1385 of the electrical interconnect 1326. The rear-facing light absorbing portion 1385 contributes towards the absorption of light within the display cell that interacts with the rear surface 1398 of the electrical interconnect 1326.

In some implementations, the front-facing light absorbing portion 1380 of the electrical interconnect 1326 with which ambient light 1350 interacts can have a reflectance of about 0.1 to about 1.0%, such about as 0.2%. Further, the rear-facing light absorbing portion 1385 of the electrical interconnect 1326 with which light 1351 from the backlight 1328 interacts can have a reflectance of about 0.01 to about 0.1%, such as about 0.04%.

In some implementations, the first conductive layer 1362 is or can include ITO and has a thickness of about 50 nm-100 nm. The first metal layer 1364 is or can include Mo or a Mo-containing alloy having a thickness of about 5 nm-20 nm. The second conductive layer 1366 is or can include ITO and has a thickness of about 50 nm-100 nm. The second metal layer 1368 is or can include Mo or a Mo-containing alloy and has a thickness of about 150 nm-300 nm. The third conductive layer 1370 is or can include ITO and has a thickness of about 50 nm-100 nm. The third metal layer 1372 is or can include Mo or a Mo-containing alloy having a thickness of about 5 nm-20 nm. The fourth conductive layer 1374 is or can include ITO and has a thickness of about 50 nm-100 nm.

In some implementations, the first conductive layer 1362 is or can include ITO and has a thickness of about 70 nm. The first metal layer 1364 is or can include Mo or a Mo-containing alloy having a thickness of about 10 nm. The second conductive layer 1366 is or can include ITO and has a thickness of about 70 nm. The second metal layer 1368 is or can include Mo or a Mo-containing alloy and has a thickness of about 200 nm. The third conductive layer 1370 is or can include ITO and has a thickness of about 70 nm. The third metal layer 1372 is or can include Mo or a Mo-containing alloy having a thickness of about 10 nm. The fourth conductive layer 1374 is or can include ITO and has a thickness of about 70 nm.

In some implementations, the first, second and third metal layers 1364, 1368 and 1372 can be or can include other suitable metals and metal alloys that can provide desired light absorption for one or more primary colors in place of, or in combination with, Mo or Mo-containing alloys. Examples of some such metals include Al, Ti and rough Ti. In some implementations, one or more of the first, second or third metal layers 1364, 1368 and 1372 can include Mo or Mo-containing alloys, while the other layers of the first, second or third metal layers 1364, 1368 and 1372 can include another metal or metal containing alloys.

In some implementations, the thickness of materials for the first, second or third metal layers 1364, 1368 and 1372 and the first, second, third or fourth conductive layers 1362, 1366, 1370 and 1374 also can affect the overall light absorption of the electrical interconnect 1326. The overall level of light absorption relies on the properties of each of the materials, their refractive indexes and their thicknesses. Thus, the degree of destructive interference provided by the electrical interconnect 1326 can be increased by adjusting the thicknesses of the constituent layers of material. Accordingly, the thickness of one or more of the metal layers 1364, 1368 and 1372 and the conductive layers 1362, 1366, 1370 and 1374 are tuned to yield improved light absorption characteristics. Specific thicknesses may be selected by use of optimization software configured to iteratively simulate various combinations of material thicknesses.

In some implementations, the choice of materials for the first, second or third metal layers 1364, 1368 and 1372 and the first, second, third or fourth conductive layers 1362, 1366, 1370 and 1374 also can affect the overall light absorption of the electrical interconnect 1326. In particular, some metal materials become less transmissive when paired with certain materials. As such, when selecting materials for inclusion in the electrical interconnect 1326, consideration should be given not only to tuning the thicknesses of the individual layers, but also to the type of materials used in each of the layers with respect to the other layer.

In some implementations, the electrical interconnect 1326 may not include one or more of the layers shown in FIG. 13B. For example, in some implementations, light absorbing structures can be formed using a fewer or greater number of conductive layers or metal layers used to form the electrical interconnect 1326. In some implementations, the front facing light absorbing portion 1380 of the electrical interconnect 1326 can include the second conductive layer 1366 and the second metal layer 1368, while the rear facing light absorbing portion 1385 of the electrical interconnect 1326 can include the second metal layer 1368 and the third conductive layer 1370. As such, the electrical interconnect 1326 can include three layers, namely, the second conductive layer 1366, the second metal layer 1368 and the third conductive layer 1370.

In some other implementations, the front facing light absorbing portion 1380 of the electrical interconnect 1326 can include the first metal layer 1364, the second conductive layer 1366 and the second metal layer 1368, while the rear facing light absorbing portion 1385 of the electrical interconnect 1326 can include the second metal layer 1368, the third conductive layer 1370 and the third metal layer 1372. In such implementations, the electrical interconnect 1326 includes five layers, namely, the first metal layer 1364, the second conductive layer 1366, the second metal layer 1368, the third conductive layer 1370 and the third metal layer 1372. In some such implementations, one or both of the front facing light absorbing portion 1380 and the rear facing light absorbing portion 1385 can include one or more additional conductive layers. For example, the front facing light absorbing portion 1380 can include the first conductive layer 1362 or the rear facing light absorbing portion 1385 can include the fourth conductive layer 1374.

In some other implementations, the front facing light absorbing portion 1380 and the rear facing light absorbing portion 1385 can include a different number of layers. For instance, the front facing light absorbing portion 1380 can include four layers, namely the first conductive layer 1362, the first metal layer 1364, the second conductive layer 1366 and the second metal layer 1368, while the rear facing light absorbing portion 1385 can include three layers, namely the second metal layer 1368, the third conductive layer 1370 and the third metal layer 1372.

In some implementations, the thicknesses of the layers that do form the electrical interconnect 1326 may be tuned to yield improved light absorbing characteristics. Specific thicknesses may be selected by use of optimization software configured to iteratively simulate various combinations of material thicknesses.

Although FIG. 13B shows an example electrical interconnect that functions as a light absorbing structure, other electrical components that have metal layers also can have low reflectance by incorporating one or more of the layers of the electrical interconnect 1326. For example, the metal layers of electrical components, such as the metal layers of transistors, or the metal plates of capacitors can be formed using one or more layers of the electrical interconnect 1326. In one example, the gate of a transistor, such as the transistor 1325 can be formed from a similar stack of materials used to form the electrical interconnect 1326. For example, the gate of the transistor can be formed from the materials that form the front-facing light absorbing portion 1380 of the electrical interconnect 1326, i.e., layers 1368, 1366, and 1364. As a result, ambient light reflection off of the transistor is reduced and the contrast ratio of a display is improved. In some implementations, the remaining terminals of the transistor 1325 may be formed from or include the stack of materials used in the front-facing light absorbing portion 1380 and/or the rear-facing light absorbing portion 1385, depending on whether they are exposed to ambient or display generated light. In this way, the transistor 1325 also can function as a light absorbing structure, reducing ambient light reflection off of the front facing surface of the transistor 1325 and the reflection of light within the display off of the rear facing surface of the transistor 1325.

In some implementations, at least a portion of an electrical component of the backplane circuitry that is configured to serve as a light absorbing structure can be formed on a rear substrate of a MEMS up display apparatus, such as the transparent substrate 505 of the display apparatus 500 shown in FIG. 5. In some such implementations, the light absorbing structure can include a dark metal layer, a metal base layer and a highly reflective dielectric layer. The dark metal layer can be or include a relatively low reflectance metal, for example, Ti, Mo, or black Cr. The metal base layer can be a relatively thick metal layer. For example, the metal base layer can have a thickness of at least 150 nm. In some implementations, the metal base layer can be or include Al, Ti or Mo or a Mo-containing alloy. The light absorbing structure can be formed on the transparent substrate, which can be a glass substrate, such that the highly reflective dielectric stack of layers is formed on top of the glass, the metal base layer is formed on the dielectric stack of layers and the dark metal layer is formed on the metal base layer. In some other implementations, the light absorbing structure can be formed from a similar stack of materials used to form the electrical interconnect 1326. In particular, the light absorbing structure may include the stack of materials used in the front-facing light absorbing portion 1380 used to form the electrical interconnect 1326.

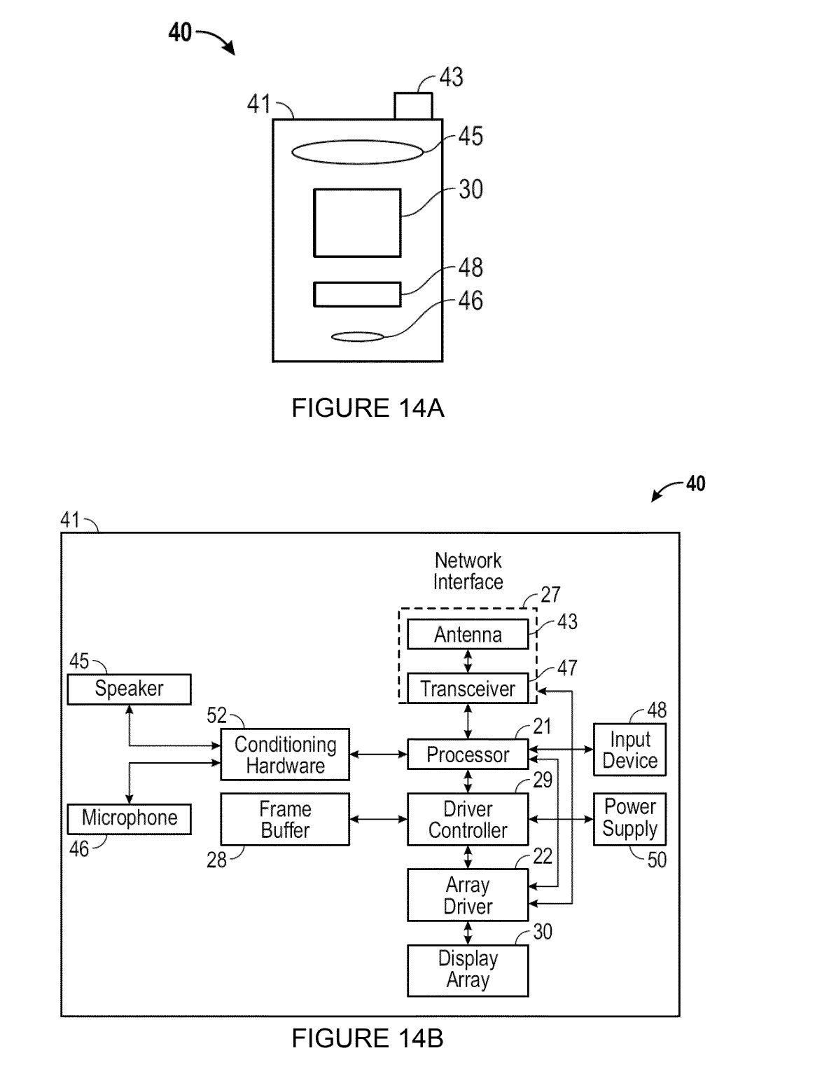

FIGS. 14A and 14B are examples of system block diagrams illustrating a display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL), organic light-emitting diode (OLED), super-twisted nematic liquid crystal display (STN LCD), or thin film transistor (TFT) LCD, or a non-flat-panel display, such as a cathode ray tube (CRT) or other tube device.

The components of the display device 40 are schematically illustrated in FIG. 14A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 14A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 801.11 standard, including IEEE 801.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3 G, 4 G or 5 G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22, and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as the controller 134 described above with respect to FIG. 1). Additionally, the array driver 22 can be a conventional driver or a bi-stable display driver. Moreover, the display array 30 can be a conventional display array or a bi-stable display array (such as a display including an array of display elements, such as light modulator array 320 depicted in FIG. 3B). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a light absorbing structure including:
a metal layer; and
a semiconductor layer in contact with the metal layer, wherein each of the metal layer and the semiconductor layer has a thickness less than or equal to about 50 nm.

2. The apparatus of claim 1, wherein a reflectance of the light absorbing structure across at least a portion of the visible spectrum and across a range of incidence angles of about 45° about an axis normal to the light absorbing structure is less than about 15%.

3. The apparatus of claim 1, wherein the metal layer includes at least one of titanium (Ti), molybdenum (Mo), a Mo-containing alloy, and aluminum (Al).

4. The apparatus of claim 1, wherein the semiconductor layer includes at least one of silicon (Si), amorphous silicon (a-Si) and germanium (Ge).

5. The apparatus of claim 1, wherein the metal layer is configured to absorb light corresponding to a primary color, and the semiconductor layer is configured to absorb light corresponding to a different primary color.

6. The apparatus of claim 1, wherein the light absorbing structure further comprises a dielectric layer in contact with the metal layer.

7. The apparatus of claim 1, wherein the light absorbing structure further comprises a second metal layer in contact with the semiconductor layer, wherein the second metal has a thickness greater than the metal layer.

8. The apparatus of claim 1, wherein a first semiconductor surface of the semiconductor layer is in contact with the first metal surface of the metal layer, and wherein the light absorbing structure further comprises:
a dielectric layer in contact with a second metal surface of the metal layer opposite the first metal surface; and
a second metal layer in contact with a second semiconductor surface of the semiconductor layer opposite the first semiconductor surface, wherein the second metal has a thickness greater than the metal layer.

9. The apparatus of claim 8, wherein the second metal layer includes at least one of Ti, Mo, a Mo-containing alloy, and Al and the dielectric layer includes at least one of silicon nitride (SiNₓ) and indium tin oxide (ITO).

10. The apparatus of claim 1, wherein at least one of the metal layer and the semiconductor layer has a thickness less than or equal to about 25 nm.

11. The apparatus of claim 1, further comprising:
a display including an array of display elements;
a processor that is configured to communicate with the display, the processor being configured to process image data; and
a memory device that is configured to communicate with the processor.

12. The apparatus of claim 11, further comprising:
a driver circuit configured to send at least one signal to the display; and wherein
the controller further configured to send at least a portion of the image data to the driver circuit.

13. The apparatus of claim 11, further comprising:
an image source module configured to send the image data to the processor, wherein the image source module comprises at least one of a receiver, transceiver, and transmitter.

14. The apparatus of claim 11, further comprising:
an input device configured to receive input data and to communicate the input data to the processor.

15. The apparatus of claim 11, wherein the display elements include electromechanical system (EMS) display elements.

16. The apparatus of claim 11, further comprising:
a first substrate configured to support the array of display elements; and
a second substrate separated from the first substrate.

17. The apparatus of claim 11, wherein at least one of the first substrate, the second substrate and the display elements comprises the light absorbing structure.

18. A method of manufacturing a light absorbing structure, comprising:
depositing, on a substrate, one of a metal layer and a semiconductor layer of a thickness of less than about 50 nm; and
depositing directly on top of the one of the metal layer and the semiconductor layer, a second layer of a thickness of less than about 50 nm, the second layer corresponding to another of the metal layer and the semiconductor layer.

19. The method of claim 18, wherein a reflectance of the light absorbing structure across at least a portion of the visible spectrum and across a 45° range of incidence angles is up to about 15%.

20. The method of claim 18, wherein the metal layer includes at least one of titanium (Ti), molybdenum (Mo), a Mo-containing alloy, and aluminum (Al).

21. The method of claim 18, wherein the semiconductor layer includes at least one of silicon (Si), amorphous silicon (a-Si) and germanium (Ge).

22. The method of claim 18, wherein the metal layer is configured to absorb light corresponding to a primary color, and the semiconductor layer is configured to absorb light corresponding to a different primary color.

23. The method of claim 18, further comprising depositing a dielectric layer.

24. The method of claim 18, further comprising depositing a second metal layer having a thickness of greater than about 100 nm.

25. An apparatus comprising:
a light absorbing structure including:
a metal layer having a thickness less than or equal to about 50 nm; and
a second layer in contact with the metal layer, the second layer including one of an indium tin oxide (ITO) layer having a thickness less than or equal to about 100 nm and a high refractive index dielectric layer having a thickness less than or equal to about 200 nm, wherein a refractive index of the high refractive index dielectric layer is greater than or equal to about 1.7.

26. The apparatus of claim 25, wherein a reflectance of the light absorbing structure across at least a portion of the visible spectrum and across a range of incidence angles of about 45° about an axis normal to the light absorbing structure is less than about 15%.

27. The apparatus of claim 25, wherein the metal layer includes at least one of titanium (Ti), molybdenum (Mo), a Mo-containing alloy, and aluminum (Al).

28. The apparatus of claim 25, wherein the second layer includes the ITO layer having a thickness less than or equal to about 70 nm.

29. The apparatus of claim 25, wherein the second layer includes at least one of silicon nitride (SiNₓ) and titanium oxide (TiO₂).

30. The apparatus of claim 25, wherein the light absorbing structure further comprises a second metal layer in contact with the second layer, wherein the second metal has a thickness greater than the metal layer.

31. The apparatus of claim 25, wherein a first surface of the second layer is in contact with the first metal surface of the metal layer, and wherein the light absorbing structure further comprises:
a dielectric layer in contact with a second metal surface of the metal layer opposite the first metal surface; and
a second metal layer in contact with a second surface of the second layer opposite the first surface, wherein the second metal has a thickness greater than the metal layer.
